(19) United States
(12) Patent Application Publication
(10) Pub. No.: US 2023/0148642 A1
(43) Pub. Date: May 18, 2023

(54) SWEETENER FORMULATIONS

(71) Applicant: DOUXMATOK LTD., Petach Tikva (IL)

(72) Inventors: David TSIVION, Kfar Shmaryahu (IL); Ronit ROMM, Jerusalem (IL); Alejandro MARABI, Tel Aviv (IL); Liron BITAN, Petach Tikva (IL); Naama LAHAV, Hod Hasharon (IL); Alexander TRACHTENBERG, Ramat Gan (IL); Bar PINCHAS, Hod-HaSharon (IL); Orel SHKALO, Kfar Saba (IL); Danielle LUBOTZKY, Givat Shmuel (IL); Moran FATTAL, Tel Aviv (IL)

(21) Appl. No.: 17/954,352

(22) Filed: Sep. 28, 2022

Related U.S. Application Data
(63) Continuation-in-part of application No. PCT/IB2021/052753, filed on Apr. 1, 2021.
(60) Provisional application No. 63/003,549, filed on Apr. 1, 2020.

(51) Int. Cl. A23L 27/30; A23L 29/20; A23P 10/40

(52) U.S. Cl. CPC A23L 27/30; A23L 29/20; A23P 10/40

(57) ABSTRACT

Sweetener formulations including (a) sweetener particles containing a sweetener selected from the group consisting of a sweetener carbohydrate such as sucrose or fructose, and a sweetener polyol, and (b) a polysaccharide disposed within the sweetener particles, wherein the polysaccharide is a mucoadhesive agent, and edible products containing such sweetener formulations.

This application is a Continuation-In-Part (CIP) of International Application PCT/IB2021/052753 filed on Apr. 1, 2021, which draws priority from U.S. Provisional Pat. Application No. 63/003,549, filed Apr. 1, 2020, which applications are incorporated by reference for all purposes as if fully set forth herein.

### FIELD AND BACKGROUND OF THE INVENTION

The present invention relates to sweet formulations containing polysaccharide within the sweetener particles, and, more particularly, to such formulations, or the polysaccharide therein, exhibiting mucoadhesive properties.

### SUMMARY OF THE INVENTION

According to teachings of the present invention there is provided a formulation including sweetener particles containing a sweetener selected from the group consisting of a sweetener carbohydrate and a sweetener polyol; and a polysaccharide disposed within the sweetener particles; wherein a mucosal adhesion of the formulation is greater than that of a control composition, the control composition being devoid of the polysaccharide, but being otherwise identical to the formulation; and wherein a weight-to-weight ratio of the polysaccharide to the sweetener within the formulation or within the sweetener particles is 0.03% to 1.75%.

According to still further features in the described preferred embodiments, the mucosal adhesion is greater than that of the control composition by 1% to 200%.

According to still further features in the described preferred embodiments, the mucosal adhesion is greater than that of the control composition by 1% to 80%.

According to still further features in the described preferred embodiments, the mucosal adhesion is greater than that of the control composition by 1.5% to 60%.

According to still further features in the described preferred embodiments, the mucosal adhesion is greater than that of the control composition by 2% to 50%.

According to still further features in the described preferred embodiments, the mucosal adhesion is greater than that of the control composition by sweetener is at least predominantly crystalline.

According to still further features in the described preferred embodiments, the weight range of the polysaccharide is 0.05% to 1.2%.

According to still further features in the described preferred embodiments, the weight range of the polysaccharide is 0.05% to 1.0%.

According to still further features in the described preferred embodiments, the weight content of the polysaccharide is at least 0.1%.

According to still further features in the described preferred embodiments, the average particle size (Dv50) of the formulation or the sweetener particles is within a range of 100 µm to 1000 µm.

According to still further features in the described preferred embodiments, the formulation further includes at least one fat; and optionally, at least one starch, wherein a total concentration of the sweetener, the at least one fat, and the at least one starch is at least 30%, on a weight basis.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings: FIG. 1 is a graph plotting the comparative sweetness index for Petit Beurre biscuits as a function of the concentration of a mucoadhesive polysaccharide (xanthan gum) in the inventive sweetener formulation utilized within the biscuits;

FIG. 2 is a graph plotting the comparative sweetness index for Petit Beurre biscuits as a function of the concentration of a mucoadhesive polysaccharide (pectin) in the inventive sweetener formulation utilized within the biscuits;

FIG. 2A is a graph plotting the comparative sweetness index for an inventive Butter Cookie containing a sweetener containing sucrose and 0.3% sodium alginate;

FIG. 2B is a graph plotting the comparative sweetness index for a comparative butter cookie containing a sweetener containing sucrose and 0.3% sodium alginate, wherein the sodium alginate in the sweetener was dry-mixed with the sucrose;

FIG. 3 is a graph plotting the comparative sweetness index for Petit Beurre biscuits as a function of the concentration of a mucoadhesive polysaccharide (sodium alginate) in the inventive sweetener formulation utilized within the biscuits;

FIG. 4 is a comparative bar graph plotting the maximum detachment force required for various sweetener formulations, as characterized by a texture analyzer, the sweetener formulations including a mucoadhesive polysaccharide (sodium alginate) sweetener formulation produced according to the present invention;

FIG. 5 is a comparative bar graph plotting the detachment work required, as characterized by a texture analyzer, for the sweetener formulations described with reference to FIG. 4;

FIG. 6 is a comparative bar graph plotting the maximum detachment force required for various sweetener formulations, as characterized by a texture analyzer, the sweetener formulations including a mucoadhesive polysaccharide (sodium alginate, 1%) sweetener formulation according to the present invention;

FIG. 7 is a comparative bar graph plotting the detachment work required, as characterized by a texture analyzer, for the sweetener formulations described with reference to FIG. 6;

FIG. 8 is a comparative bar graph plotting the calculated bioadhesion between various polysaccharide formulations and a 5% mucin preparation, based on rheological measurements;

FIG. 9 is a comparative bar graph plotting the maximum detachment force required for an inventive sweetener formulation containing a mucoadhesive polysaccharide, normalized with respect to the maximum detachment force required for a pure sucrose control sample; and

FIG. 10 is a comparative bar graph plotting the detachment work required for the identical inventive sweetener formulation, wherein the detachment work normalized with respect to the detachment work required for a pure sucrose control sample.

### DESCRIPTION OF THE PREFERRED EMBODIMENTS

The present disclosure describes improved sweetener formulations and methods for making such improved sweetener formulations and utilizing them in food products. Such sweetener formulations include one or more polysaccharides that may exhibit any of various mucoadhesive properties.

The inventors have found that the presence of polysaccharides in food may actually reduce the perceived sweetness of the food. This may be due - in part - to the increased viscosity contributed by the polysaccharides, which are often utilized for their thickening properties. Consequently, an additional quantity of sweetener (e.g., sucrose or fructose) may need to be introduced to a food to offset the deleterious influence of the polysaccharides on sweetness. This may have various ramifications on the food properties, including texture, as well as on the baking properties of the food.

The inventors have discovered that the location of the polysaccharides within the food may be of cardinal importance. Specifically, when the polysaccharides are incorporated within the sweetener particles, the polysaccharides may not negatively impact food sweetness. In fact, the inventors have surprisingly discovered that under certain conditions, the presence of the polysaccharides within the food may actually enhance food sweetness.

Without wishing to be limited by theory, the inventors believe that mucoadhesion of the polysaccharides to the mucosa or mucous membranes on the tongue and within the oral cavity may contribute to the retention of sweetener carbohydrates and sweetener polyols, resulting in an enhanced and extended sensation of sweetness. This phenomenon occurs, or is greatly enhanced, when the polysaccharides are incorporated within the sweetener particles, such that the mucosal adhesion between the mucin-containing mucosa and the polysaccharide in the sweetener particle helps to fix the sweetener particle to the oral mucosa, or to at least increase the contact time between the sweetener particle to the oral mucosa. This translates into increased activation of the sweetness sensors/receptor sites on the tongue, by way of example.

The inventors have surprisingly discovered that within a particular, low range of concentrations of polysaccharide disposed within the sweetener particles, the increased mucosal adhesion of these polysaccharides appears to more than offset various polysaccharide properties that deleteriously affect perceived sweetness. These deleterious properties include the increased viscosity of the food (inter alia reducing the solubility kinetics and hindering the transport of sweetener molecules to the sweetness sensors/receptor sites), covering and blocking oral sweetness sensors/receptor sites, and the non-sweet taste of the polysaccharide itself. By more than offsetting these deleterious polysaccharide properties, the presence of the polysaccharide within the sweetener particles may impart appreciably enhanced sweetness to the food.

Examples of such polysaccharides exhibiting mucoadhesive activity include, but are not limited to, xanthan gum, guar gum, locust bean gum, tragacanth, karaya gum, gum Arabic, agar-agar, tara gum, sodium alginate, potassium alginate, konjac mannan, gellan and pectin, including both low methoxyl pectin (LMP) and high methoxyl pectin (HMP).

As used herein in the specification and in the claims section that follows, the terms “mucoadhesion” and “mucosal adhesion” refer to the tendency of particular macromolecules such as polysaccharides to attach to a mucin layer of a mucosal surface of a human tongue.

As used herein in the specification and in the claims section that follows, the term “mucoadhesive agent” and the like refers to a substance exhibiting an affinity for attaching to a mucin layer of a mucosal surface of a human tongue, via mucoadhesion.

As used herein, the term “sweetener carbohydrate” refers to an edible sweetener having at least one carbohydrate moiety, which carbohydrate is processed within the human body to produce energy. This definition is meant to include sweetener carbohydrates having an energy value of at least 0.1 kcal/g, more typically, at least 0.2 kcal/g, more typically, at least 0.5 kcal/g, and yet more typically, at least 1.0 kcal/g. This definition is specifically meant to include allulose.

The term “sweetener carbohydrate” is specifically meant to exclude high-intensity sweeteners such as sucralose, aspartame, and acesulfame-K.

The term “sweetener”, when used alone, is meant to include both sweetener carbohydrates and sweetener polyols.

A sweetener carbohydrate produces a sweet taste when consumed by the typical human consumer. If, on a normalized sweetness scale, on a weight basis, in which sucrose is taken as a standard of 1, maltose is about 0.31, and lactose is about 0.22, the term “sweetener carbohydrate” would apply to lactose, and to any sugar or other nutritive, carbohydrate-containing sweetener having a sweetness within a range of 0.15 to 2.5 on this normalized sweetness scale. Alternatively, it may be stated that the minimum sweetness for the sugar or other nutritive, carbohydrate-containing sweetener would be that of raffinose (which has a sweetness of 0.15 on the above-mentioned scale). More typically, such a sweetener carbohydrate has a sweetness of at least 0.2, at least 0.23, at least 0.25, at least 0.27, or a sweetness within a range of 0.23 to 2.5, 0.25 to 2.5, 0.35 to 2.5, 0.45 to 2.5, 0.25 to 1.8, 0.25 to 1.5, 0.25 to 1.2, 0.25 to 1.05, 0.25 to 1.0, 0.45 to 1.7, 0.15 to 1.7, or 0.35 to 1.5 on this normalized sweetness scale.

It is noted that the relative sweetness of fructose reported in the literature has been reported to be as little as 0.91, and as much as about 1.7. For the avoidance of doubt, the term “sweetener carbohydrate” is meant to include fructose, irrespective of any of its reported relative sweetness values.

As used herein, the term “normalized sweetness scale”, refers to a relative sweetness scale, on a weight basis, in which sucrose is assigned a value of 1.00. More specifically, the normalized sweetness scale is determined according to the methods disclosed in Moscowitz, H. “Ratio Scales of Sugar Sweetness”; Perception & Psychophysics, 1970, Vol. 7 (5), in which the power function for the sugars and polyols/sugar alcohols has an exponent of 1.3 (n = 1.3), as disclosed therein in Table 3, and as provided hereinbelow.

From “Ratio Scales of Sugar Sweetness”
Percent by Weight Basis

| | Rank | Relative Sweetness |
|---|---|---|
| Sucrose | 1 | 1.00 |
| Fructose | 2 | 0.91 |
| Raftinose | 15 | 0.15 |
| Maltose | 12 | 0.31 |
| Lactose | 14 | 0.22 |
| Dulcitol | 5 | 0.46 |
| Glucose | 4 | 0.45 |
| Galactose | 6 | 0.42 |
| Sorbose | 7 | 0.41 |
| Sorbitol | 9 | 0.37 |
| Mannitol | 11 | 0.33 |
| Arabinose | 8 | 0.39 |
| Rhamnose | 10 | 0.35 |
| Glycerol | 3 | 0.50 |
| Xvlose | 13 | 0.26 |

A sweetener carbohydrate may be a monosaccharide or a disaccharide. Examples of sweetener carbohydrates include, but are not limited to, sucrose, glucose, maltose, fructose, lactose, or any combination of sweetener carbohydrates. One or more sweetener carbohydrate may be combined with one or more sweetener polyols. A sweetener carbohydrate may be naturally occurring or synthetically produced.

As used herein, the term “sweetener polyol” refers to a consumable polyol that produces a sweet taste when consumed by the typical human consumer. Non-limiting examples of sweetener polyols include xylitol, maltitol, erythritol, sorbitol, threitol, arabitol, hydrogenated starch hydrolysates (HSH), isomalt, lactitol, mannitol, or galactitol (dulcitol). In many instances, the polyol is a sugar alcohol. A sugar alcohol can be produced from a carbohydrate by any known method of reduction (via a chemical or biological transformation) of an acid or aldehyde to an alcohol. In other cases, a sweetener polyol can be synthesized from a parent carbohydrate. Alternatively, a sweetener polyol may be obtained from a biological source.

For the avoidance of doubt, the term “sweetener polyol” is meant to include any polyol/sugar alcohol having a sweetness within a range of 0.15 to 2.5 on the above-described normalized sweetness scale. More typically, such a sweetener polyol has a sweetness within a range of 0.15 to 1.5, 0.15 to 1.0, 0.15 to 0.8, 0.15 to 0.7, 0.20 to 0.7, 0.15 to 0.6, or 0.25 to 0.6, on this normalized sweetness scale.

As used herein in the specification and in the claims section that follows, the term “polysaccharide” refers to a polymer comprising a plurality of monosaccharide building blocks or units, adjacent monosaccharide units being bound or linked by a glycosidic linkage. Such linkages may be effected using various enzymes. A polysaccharide may be a homopolysaccharide, in which all of the monosaccharide building blocks are identical (e.g., curdlan), or a heteropolysaccharide, which contains at least two monosaccharide building blocks (e.g., sodium alginate, tara gum).

Depending on which monosaccharides are connected, and which carbon atom in the monosaccharides is involved in the linkage, polysaccharides may assume a variety of forms. A polysaccharide having solely a straight chain of monosaccharides is a “linear” polysaccharide; a polysaccharide having a branched backbone is a “branched” polysaccharide.

As used herein in the specification and in the claims section that follows, the term “glycosidic linkage” refers to covalent bonding between adjacent building blocks or monosaccharide units within a polysaccharide by means of oxygen (“O-glycosidic” linkage), nitrogen (“N-glycosidic” linkage), or sulfur (“S-glycosidic” linkage). Most typically, the glycosidic linkage is an O-glycosidic linkage.

As used herein in the specification and in the claims section that follows, the term “unsubstituted monosaccharide”, with respect to building blocks within the polysaccharide, refers to a non-substituted cyclic monosaccharide such as a cyclic hexose sugar, cyclic pentose sugar, and cyclic heptose sugar.

As used herein in the specification and in the claims section that follows, the term “monosaccharide”, with respect to building blocks within the polysaccharide, is meant to include unsubstituted monosaccharides and substituted monosaccharides.

As used herein in the specification and in the claims section that follows, the term “substituted monosaccharide”, with respect to building blocks within the polysaccharide, refers to a cyclic monosaccharide having at least one moiety other than hydrogen (H-), hydrocarbon (e.g., alkyl), or hydroxyl (HO-). Typical examples of moieties in such substituted monosaccharides include acetyl (e.g., konjac mannan, locust bean gum), amino (e.g., chitosan), methoxy (e.g., pectin), sulfate (e.g., carrageenan), pyruvate (e.g., carrageenan, xanthan gum), a carboxylate such as acetate (e.g., xanthan gum) and acyl (e.g., gellan gum) moieties.

In some embodiments, the carboxylate moiety is, or includes, a uronic acid. Examples include pectin and sodium alginate.

In some embodiments, the polysaccharide is, or includes, an anionic polysaccharide. Examples include gellan gum, xanthan gum, pectin, and sodium alginate.

In some embodiments, the polysaccharide is, or includes, a non-ionic polysaccharide. Examples include locust bean gum (LBG) and agar-agar.

In some embodiments, the polysaccharides utilized in accordance with the present invention have a specific surface area of at most 150 m²/g, at most 125 m²/g, and more typically, at most 100 m²/g, at most 75 m²/g, at most 50 m²/g, at most 25 m²/g, or at most 10 m²/g.

In some embodiments, the polysaccharides utilized in accordance with the present invention have an average particle size (Dv50) of at least 5 µm or at least 10 µm, and more typically, at least 20 µm, at least 35 µm, or at least 50 µm.

The sweetener formulation is typically devoid of silicon-containing species such as silica. In some embodiments, the concentration of silicon within the sweetener formulation is at most 1%, at most 0.5%, at most 0.2%, at most 0.1%, at most 0.05%, at most 0.02%, at most 0.01%, at most 0.005%, or at most 0.003%. Typically, the concentration of silicon within the sweetener formulation is at most 0.002%, at most 0.001%, or the sweetener formulation is devoid of silicon.

The sweetener formulation is typically produced under controlled crystallization conditions in which both average (global) supersaturation and local supersaturation are monitored and maintained at low levels. This may be achieved by appropriate crystallizer geometry, low evaporation rate, and suitable mixing arrangement, speed, and energy per unit crystallization volume. The resultant sweetener formulation is crystalline or highly crystalline, as evidenced by optical microscopy, and by X-Ray Diffraction (XRD), including quantitative XRD. This is particularly characteristic of sugar-based sweetener formulations such as sucrose-based formulations.

The mucoadhesive agents for use in accordance with the formulations and methods of the present invention may have various mucoadhesive properties. For example, the mucoadhesive agents may have numerous hydrophilic groups, such as hydroxyl and carboxyl groups, which aid attachment to mucus or cell membranes through various interactions such as hydrogen bonding and hydrophobic or electrostatic interactions.

Mucoadhesion may generally refer to the attachment of particular macromolecules to a mucin layer of a mucosal surface of a human tongue.

The mucoadhesive agent’s affinity for attaching to a mucin layer of a mucosal surface of a human tongue, may be characterized or quantified by at least one of several characterization methods, some of which are provided in the Examples Section hereinbelow.

### EXAMPLES

Reference is now made to the following examples, which together with the above descriptions, illustrate the invention in a non-limiting fashion.

EQUIPMENT

List of Equipment Used:

| Instruments | Manufacturer | Model | Measuring range | Units | Geometry |
|---|---|---|---|---|---|
| High shear mixer | IKA | IKA T 25 ULTRA-TURRAX® | 3000-25000 | rpm | |
| | Silverson | L5M-A | 0-8000 | rpm | |
| Vacuum mixer-dryer (cooking mixer) | Stephan | UMC 5 | 300-3000 | 1/min | |
| Vacuum pump | Vacuubrand | MZ 2C NT | 50 | Hz | |
| Laboratory oven | MRC Ltd | DFO-150 | 25-250 | °C | |
| Ultra centrifugal mill | Retsch | ZM200 | 50 | Hz | |
| Pocket Refractometer | ATAGO | PAL-BX/RI | 0.0-93.0 | % | |
| Texture analyzer | Stable Micro Systems | TA.XTplus | 0-5000 | gr | A/MUC Muco-adhesion Test Rig |
| Rheometer | Anton Paar GmbH | MCR 92 P/N: 159000 | 0-1000 | 1/s | Bob-cup cylinder |

MATERIALS

List of Materials Used:

| | | |
|---|---|---|
| Material | Manufacturer | Type/Product name |
| Sodium alginate | FMC Biopolymers Corporation | Manucol DH |
| | Ingredients Solutions, Inc. | Nalgin MV-120 |
| | TIC gum | TICA-algin ® 400 Powder |
| | Qingdao Lanneret Biochemical Co., Ltd | Lanneret |
| Pectin | CP Kelco | HMP: GENU pectin type D 100 buffered |
| | TIC gum | HMP: Pre-Hydrated® Pectin 1694 Powder |
| | Cargill | LMP: Unipectine of 100C LMP |
| | TIC gum | LMP: TIC Pretested® Apple Pectin LMA |
| | Goodchem Technology Co., Limited | HMP: Citrus Pectin HM |
| Guar gum | Rama Gum | Ricol |
| | TIC gum | Pre-Hydrated® Guar Gum 8/24 Powder |
| | Lucid Colloids Ltd. | Edicol FGDG 8 |
| Xanthan Gum | Cargill | CX911 |
| | TIC gum | Pre-Hydrated® Ticaxan® Xanthan EC NGMO |
| | CP Kelco | KELTROL |
| Gum Arabic | Nnexira | Instant gum BB |
| | TIC gum | Pre-Hydrated® Gum Arabic SF Powder |
| | Norevo GmbH | Gum acacia |
| Gellan Gum | CP Kelco | Kelcogel ® LT100 |
| | TIC gum | Ticagel® Gellan L-6 |
| | TIC gum | Ticagel® Gellan HS NGMO |
| | CP Kelco | Kelcogel ® HA B |
| | Amstel Products BV | Gellan gum |
| Agar-Agar | TIC gum | 100 |
| | Marine Hydrocolloids | Agar Agar Gracilaria |
| | Norevo GmbH | Agar Agar |
| Konjac-Mannan | TIC gum | High viscosity |
| | Gfn-Selco | Konjac Mannan® Gel Powder |
| | BOC Sciences | Konjac glucomannan |
| Tara Gum | TIC gum | HV |
| | TIC gum | 100 |
| | Ingredients UK Ltd | Tara gum |
| | Amstel Products BV | Tara gum |
| Locust Bean Gum (LBG) | TIC gum | POR/A2 |
| | CP Kelco | GENU® GUM Refined Locust Bean Gum |
| | Amstel Products BV | LBG |
| Mucin Type II | Sigma-Aldrich | Type II |
| | Creative BioMart | |
| | CYMIT QUIMICA S.L. | |
| Inulin | Beneo | Orafti Highly Soluble Inulin |
| | Cosucra | Fibruline |
| | Sensus | Frutafit CLR |

### Example 1

### Production of a Polysaccharide-Sweetener Dispersion

The polysaccharide and carbohydrate sweetener powders are mixed or blended. The resulting powder mixture is added gradually to water. The requisite amount of polysaccharide is calculated in ratio to the carbohydrate sweetener (weight-weight). For example: in order to prepare about 1 kilogram (typically 65°Bx) of syrup containing 0.1% polysaccharide with respect to the carbohydrate sweetener, 0.65 grams of the polysaccharide are mixed with 650 grams of the carbohydrate sweetener. This mixture is added gradually (under constant mixing) to 350 grams of water, typically at room temperature. The mixing vessel is stirred using an overhead stirrer, typically at 50-800 RPM for at least 45 minutes, or for at least 7 minutes using a high shear mixer (up to 10,000 RPM for IKA; up to 5,000 RPM for Silverson), until the polysaccharide is fully dispersed, and the refractometer shows ca. 65°Bx.

For polysaccharides that are more difficult to disperse, the water fraction may be pre-heated.

### Example 2

### Production of a Polysaccharide-Sweetener Dispersion - Full Dispersion

A concentrated sweetener syrup containing one or more carbohydrate sweeteners and/or one or more polyol (typically sugar alcohol) sweeteners, is prepared prior to the addition of the polysaccharide, from room temperature to as much as 80° C. in some cases. The default temperature is 60° C. for sucrose and any other di-saccharides, and 70° C. for other sweetener species. The concentration is about 65 wt% for most of the carbohydrate and polyol sweeteners. Some of the lower solubility sweeteners, may require higher water concentrations and/or temperatures in order to fully dissolve. The polysaccharide is then added incrementally or instantaneously under constant mixing. Once the polysaccharide addition has been completed, the mixing vessel continues to be stirred using an overhead stirrer, typically at 50-800 RPM for at least 45 minutes, or for at least 7 minutes using a high shear mixer (up to 10,000 RPM for IKA; up to 5,000 RPM for Silverson), until the polysaccharide is fully dispersed.

When necessary, the syrup is heated to facilitate the dispersion of the polysaccharide.

### Example 3

### Production of a Polysaccharide-Sweetener Dispersion - Full Dispersion

The polysaccharide is first dispersed in water. In the case of some polysaccharides, the dispersion may be best performed according to the instructions of the polysaccharide manufacturer (e.g., dispersing incrementally in hot water). Once the polysaccharide is fully dispersed, the sweetener (carbohydrate or polyol) is gradually introduced under constant mixing, from room temperature to as much as 80° C. in some cases. The default temperature is 60° C. for sucrose and any other di-saccharides, and 70° C. for other sweetener species. Mixing may be effected by means of an overhead stirrer (50-800 RPM for at least 45 minutes) or by means of a high-shear mixer (up to 10,000 RPM for at least 7 minutes when using IKA; up to 5,000 RPM for at least 7 minutes when using the Silverson).

Thus, to prepare about a kilogram of a carbohydrate or polyol sweetener syrup containing about 65% carbohydrate sweetener and 0.1% polysaccharide with respect to the carbohydrate sweetener, 0.65 grams of the polysaccharide are first dispersed in 350 grams water. Subsequently, 650 grams of the carbohydrate sweetener are added gradually to the polysaccharide dispersion to produce the syrup.

### Example 4

### Production of a Polysaccharide-Sweetener Dispersion — Partial Dispersion

Partial dispersion of the polysaccharide may be deliberately effected. A concentrated sweetener syrup (carbohydrate or polyol) is prepared prior to the addition of the polysaccharide, as described in Example 2. The polysaccharide is then added in instantaneous or substantially instantaneous fashion, without mixing or with gentle mixing, typically up to about 1 minute, so as to deliberately produce small aggregates. In this manner, a concentrated syrup containing partially dispersed polysaccharides is produced.

In this “partial dispersion” procedure, it may best to deviate from the dispersion instructions of the polysaccharide manufacturer, in order to mitigate the dispersion.

### Example 5

### Crystallization of a Sweetener Product From the Concentrated Syrup

Concentrated syrup (e.g., produced in any of the above-provided examples) is transferred to the heated double-jacketed vessel of the vacuum dryer (e.g., Stephan). The vessel is heated (typically 60° C.-70° C.), maintained under vacuum (typically 50-300 mbar), and mixed constantly, so as to evaporate the water under controlled crystallization conditions to produce a crystalline sweetener formulation, and eventually producing a fine dry powder.

Following crystallization, the powder may be transferred to an oven operating at 65° C. for further drying for several hours or overnight.

### Example 6

### Production of a Polysaccharide-Sweetener Dispersion -- Minimal Dispersion

A concentrated sweetener syrup (carbohydrate or polyol) is prepared, as described In Example 2. The concentrated syrup (carbohydrate sweetener and water) is transferred to the vacuum mixer-dryer vessel and mixed constantly under vacuum (50-300 mbar) and heating (55° C.-70° C.) so as to evaporate water and further concentrate the syrup. When the syrup is further concentrated to ca. 70-80 wt.%, the vacuum is released, and the polysaccharide is added to the concentrated syrup.

The polysaccharide is pre-dispersed in a vial. The liquid “dispersant” is typically water, but ethanol or ethanol/water mixtures may also be employed, as necessary, so that the solids are fully suspended. Typically, the polysaccharide to liquid ratio in the pre-dispersion is within a range of 1:1 to 1:5. Mixing is performed by manual shaking of the vial. The contents of the vial are then introduced to the concentrated syrup. The heating and vacuum are reapplied, and the syrup is mixed with the polysaccharide as water evaporates, and controlled crystallization conditions are maintained until a powder is obtained.

Optionally, the powder may be transferred to an oven operating at 65° C. for further drying for several hours or overnight.

### Example 7

A dispersion containing 0.25% xanthan gum (with respect to the carbohydrate sweetener) was prepared according to Example 3. 1.63 grams of xanthan gum were dispersed in 350 grams water. Subsequently, 650 grams sucrose were added gradually to the xanthan gum dispersion to produce a concentrated syrup. The syrup was transferred to the heated double-jacketed vessel of the vacuum dryer which was heated and maintained under vacuum according to Example 5, to produce a fine dry powder.

### Example 8

A dispersion containing 0.15% xanthan gum was prepared according to Example 3. 0.98 grams of xanthan gum were dispersed in 350 grams water. Subsequently, 650 grams sucrose were added gradually to the xanthan gum dispersion to produce a concentrated syrup. The syrup was transferred to the heated double-jacketed vessel of the vacuum dryer which was heated and maintained under vacuum according to Example 5, to produce a fine dry powder.

### Example 9

A dispersion containing 1.0% xanthan gum was prepared according to Example 3. 6.5 grams of xanthan gum were dispersed in 350 grams water. Subsequently, 650 grams sucrose were added gradually to the xanthan gum dispersion to produce a concentrated syrup. The syrup was transferred to the heated double-jacketed vessel of the vacuum dryer which was heated and maintained under vacuum according to Example 5, to produce a fine dry powder.

### Example 10

A dispersion containing 0.1% xanthan gum was prepared according to Example 3. 0.65 grams of xanthan gum were dispersed in 350 grams water. Subsequently, 650 grams sucrose were added gradually to the xanthan gum dispersion to produce a concentrated syrup. The syrup was transferred to the heated double-jacketed vessel of the vacuum dryer which was heated and maintained under vacuum according to Example 5, to produce a fine dry powder.

### Example 11

A dispersion containing 0.05% xanthan gum was prepared according to Example 3. 0.32 grams of xanthan gum were dispersed in 350 grams water. Subsequently, 650 grams sucrose were added gradually to the xanthan gum dispersion to produce a concentrated syrup. The syrup was transferred to the heated double-jacketed vessel of the vacuum dryer which was heated and maintained under vacuum according to Example 5, to produce a fine dry powder.

### Example 12

A dispersion containing 1.5% xanthan gum was prepared according to Example 3. 9.75 grams of xanthan gum were dispersed in 350 grams water. Subsequently, 650 grams sucrose were added gradually to the xanthan gum dispersion to produce a concentrated syrup. The syrup was transferred to the heated double-jacketed vessel of the vacuum dryer which was heated and maintained under vacuum according to Example 5, to produce a fine dry powder.

### Example 13

A dispersion containing 2.0% xanthan gum was prepared according to Example 3. 13.0 grams of xanthan gum were dispersed in 350 grams water. Subsequently, 650 grams sucrose were added gradually to the xanthan gum dispersion to produce a concentrated syrup. The syrup was transferred to the heated double-jacketed vessel of the vacuum dryer which was heated and maintained under vacuum according to Example 5, to produce a fine dry powder.

### Examples 14-20

The formulations of Examples 7 to 13 were prepared, but using fructose instead of sucrose.

### Example 21

A dispersion containing 0.1% agar-agar was prepared according to Example 3. 0.65 grams of agar-agar were dispersed in 350 grams water. Subsequently, 650 grams sucrose were added gradually to the agar-agar dispersion to produce a concentrated syrup. The syrup was transferred to the heated double-jacketed vessel of the vacuum dryer which was heated and maintained under vacuum according to Example 5, to produce a fine dry powder.

### Example 22

A dispersion containing 0.04% agar-agar was prepared according to Example 3. 0.26 grams of agar-agar were dispersed in 350 grams water. Subsequently, 650 grams sucrose were added gradually to the agar-agar dispersion to produce a concentrated syrup. The syrup was transferred to the heated double-jacketed vessel of the vacuum dryer which was heated and maintained under vacuum according to Example 5, to produce a fine dry powder.

### Example 23

A dispersion containing 1.2% agar-agar was prepared according to Example 3. 7.8 grams of agar-agar were dispersed in 350 grams water. Subsequently, 650 grams sucrose were added gradually to the agar-agar dispersion to produce a concentrated syrup. The syrup was transferred to the heated double-jacketed vessel of the vacuum dryer which was heated and maintained under vacuum according to Example 5, to produce a fine dry powder.

### Example 24

A dispersion containing 0.1% agar-agar was prepared according to Example 3. 0.65 grams of agar-agar were dispersed in 550 grams water. Subsequently, 650 grams glucose were added gradually to the agar-agar dispersion to produce a concentrated syrup. The syrup was transferred to the heated double-jacketed vessel of the vacuum dryer which was heated and maintained under vacuum according to Example 5, to produce a fine dry powder.

### Example 25

A dispersion containing 0.04% agar-agar was prepared according to Example 3. 0.26 grams of agar-agar were dispersed in 550 grams water. Subsequently, 650 grams glucose were added gradually to the agar-agar dispersion to produce a concentrated syrup. The syrup was transferred to the heated double-jacketed vessel of the vacuum dryer which was heated and maintained under vacuum according to Example 5, to produce a fine dry powder.

### Example 26

A dispersion containing 1.2% agar-agar was prepared according to Example 3. 7.8 grams of agar-agar were dispersed in 550 grams water. Subsequently, 650 grams glucose were added gradually to the agar-agar dispersion to produce a concentrated syrup. The syrup was transferred to the heated double-jacketed vessel of the vacuum dryer which was heated and maintained under vacuum according to Example 5, to produce a fine dry powder.

### Example 27

A dispersion containing 0.1% gum Arabic was prepared according to Example 3. 0.65 grams of gum Arabic were dispersed in 350 grams water. Subsequently, 650 grams sucrose were added gradually to the gum Arabic dispersion to produce a concentrated syrup. The syrup was transferred to the heated double-jacketed vessel of the vacuum dryer which was heated and maintained under vacuum according to Example 5, to produce a fine dry powder.

### Example 28

A dispersion containing 0.1% sodium alginate was prepared according to Example 3. 0.65 grams of sodium alginate were dispersed in 550 grams water. Subsequently, 650 grams glucose were added gradually to the sodium alginate dispersion to produce a concentrated syrup. The syrup was transferred to the heated double-jacketed vessel of the vacuum dryer which was heated and maintained under vacuum according to Example 5, to produce a fine dry powder.

### Example 29

A dispersion containing 0.1% sodium alginate was prepared according to Example 3. 0.65 grams of sodium alginate were dispersed in 350 grams water. Subsequently, 650 grams maltitol were added gradually to the sodium alginate dispersion to produce a concentrated syrup. The syrup was transferred to the heated double-jacketed vessel of the vacuum dryer which was heated and maintained under vacuum according to Example 5, to produce a fine dry powder.

### Example 30

A dispersion containing 0.1% sodium alginate was prepared according to Example 3. 0.65 grams of sodium alginate were dispersed in 350 grams water. Subsequently, 650 grams sorbitol were added gradually to the sodium alginate dispersion to produce a concentrated syrup. The syrup was transferred to the heated double-jacketed vessel of the vacuum dryer which was heated and maintained under vacuum according to Example 5, to produce a fine dry powder.

### Example 31

A dispersion containing 0.1% sodium alginate was prepared according to Example 3. 0.65 grams of sodium alginate were dispersed in 350 grams water. Subsequently, 650 grams xylitol were added gradually to the sodium alginate dispersion to produce a concentrated syrup. The syrup was transferred to the heated double-jacketed vessel of the vacuum dryer which was heated and maintained under vacuum according to Example 5, to produce a fine dry powder.

### Example 32

A dispersion containing 0.1% sodium alginate was prepared according to Example 3. 0.65 grams of sodium alginate were dispersed in 350 grams water. Subsequently, 650 grams lactitol were added gradually to the sodium alginate dispersion to produce a concentrated syrup. The syrup was transferred to the heated double-jacketed vessel of the vacuum dryer which was heated and maintained under vacuum according to Example 5, to produce a fine dry powder.

### Example 33

A dispersion containing 0.3% sodium alginate was prepared according to Example 3. 1.95 grams of sodium alginate were dispersed in 350 grams water. Subsequently, 650 grams sorbitol were added gradually to the sodium alginate dispersion to produce a concentrated syrup. The syrup was transferred to the heated double-jacketed vessel of the vacuum dryer which was heated and maintained under vacuum according to Example 5, to produce a fine dry powder.

### Example 34

A dispersion containing 1.0% sodium alginate was prepared according to Example 3. 6.5 grams of sodium alginate were dispersed in 350 grams water. Subsequently, 650 grams sorbitol were added gradually to the sodium alginate dispersion to produce a concentrated syrup. The syrup was transferred to the heated double-jacketed vessel of the vacuum dryer which was heated and maintained under vacuum according to Example 5, to produce a fine dry powder.

### Example 35

A dispersion containing 0.1% guar gum was prepared according to Example 3. 0.65 grams of guar gum were dispersed in 350 grams water. Subsequently, 650 grams sucrose were added gradually to the guar gum dispersion to produce a concentrated syrup. The syrup was transferred to the heated double-jacketed vessel of the vacuum dryer which was heated and maintained under vacuum according to Example 5, to produce a fine dry powder.

### Example 36

A dispersion containing 0.5% guar gum was prepared according to Example 3. 3.25 grams of guar gum were dispersed in 350 grams water. Subsequently, 650 grams sucrose were added gradually to the guar gum dispersion to produce a concentrated syrup. The syrup was transferred to the heated double-jacketed vessel of the vacuum dryer which was heated and maintained under vacuum according to Example 5, to produce a fine dry powder.

### Example 37

A dispersion containing 1.0% guar gum was prepared according to Example 3. 6.5 grams of guar gum were dispersed in 350 grams water. Subsequently, 650 grams sucrose were added gradually to the guar gum dispersion to produce a concentrated syrup. The syrup was transferred to the heated double-jacketed vessel of the vacuum dryer which was heated and maintained under vacuum according to Example 5, to produce a fine dry powder.

### Example 38

A dispersion containing 0.1% guar gum was prepared according to Example 3. 0.65 grams of guar gum were dispersed in 550 grams water. Subsequently, 650 grams maltose were added gradually to the guar gum dispersion to produce a concentrated syrup. The syrup was transferred to the heated double-jacketed vessel of the vacuum dryer which was heated and maintained under vacuum according to Example 5, to produce a fine dry powder.

### Example 39

A dispersion containing 0.5% guar gum was prepared according to Example 3. 3.25 grams of guar gum were dispersed in 550 grams water. Subsequently, 650 grams maltose were added gradually to the guar gum dispersion to produce a concentrated syrup. The syrup was transferred to the heated double-jacketed vessel of the vacuum dryer which was heated and maintained under vacuum according to Example 5, to produce a fine dry powder.

### Example 40

A dispersion containing 1.0% guar gum was prepared according to Example 3. 6.5 grams of guar gum were dispersed in 550 grams water. Subsequently, 650 grams maltose were added gradually to the guar gum dispersion to produce a concentrated syrup. The syrup was transferred to the heated double-jacketed vessel of the vacuum dryer which was heated and maintained under vacuum according to Example 5, to produce a fine dry powder.

### Example 41

A dispersion containing 0.1% high methoxyl pectin or “HMP” was prepared according to Example 3. 0.65 grams of HMP were dispersed in 350 grams water. Subsequently, 650 grams sucrose were added gradually to the HMP dispersion to produce a concentrated syrup. The syrup was transferred to the heated double-jacketed vessel of the vacuum dryer which was heated and maintained under vacuum according to Example 5, to produce a fine dry powder.

### Example 42

A dispersion containing 0.05% HMP was prepared according to Example 3. 0.32 grams of HMP were dispersed in 350 grams water. Subsequently, 650 grams sucrose were added gradually to the HMP dispersion to produce a concentrated syrup. The syrup was transferred to the heated double-jacketed vessel of the vacuum dryer which was heated and maintained under vacuum according to Example 5, to produce a fine dry powder.

### Example 43

A dispersion containing 1.0% HMP was prepared according to Example 3. 6.5 grams of HMP were dispersed in 350 grams water. Subsequently, 650 grams sucrose were added gradually to the HMP dispersion to produce a concentrated syrup. The syrup was transferred to the heated double-jacketed vessel of the vacuum dryer which was heated and maintained under vacuum according to Example 5, to produce a fine dry powder.

### Example 44

A dispersion containing 0.01% HMP was prepared according to Example 3. 0.065 grams of HMP were dispersed in 350 grams water. Subsequently, 650 grams sucrose were added gradually to the HMP dispersion to produce a concentrated syrup. The syrup was transferred to the heated double-jacketed vessel of the vacuum dryer which was heated and maintained under vacuum according to Example 5, to produce a fine dry powder.

### Example 45

A dispersion containing 2.0% HMP was prepared according to Example 3. 13.0 grams of HMP were dispersed in 350 grams water. Subsequently, 650 grams sucrose were added gradually to the HMP dispersion to produce a concentrated syrup. The syrup was transferred to the heated double-jacketed vessel of the vacuum dryer which was heated and maintained under vacuum according to Example 5, to produce a fine dry powder.

### Example 46

A dispersion containing 0.1% low methoxyl pectin or “LMP” was prepared according to Example 3. 0.65 grams of LMP were dispersed in 350 grams water. Subsequently, 650 grams sucrose were added gradually to the LMP dispersion to produce a concentrated syrup. The syrup was transferred to the heated double-jacketed vessel of the vacuum dryer which was heated and maintained under vacuum according to Example 5, to produce a fine dry powder.

### Example 47

A dispersion containing 0.05% LMP was prepared according to Example 3. 0.32 grams of LMP were dispersed in 350 grams water. Subsequently, 650 grams sucrose were added gradually to the LMP dispersion to produce a concentrated syrup. The syrup was transferred to the heated double-jacketed vessel of the vacuum dryer which was heated and maintained under vacuum according to Example 5, to produce a fine dry powder.

### Example 48

A dispersion containing 1.0% LMP was prepared according to Example 3. 6.5 grams of LMP were dispersed in 350 grams water. Subsequently, 650 grams sucrose were added gradually to the LMP dispersion to produce a concentrated syrup. The syrup was transferred to the heated double-jacketed vessel of the vacuum dryer which was heated and maintained under vacuum according to Example 5, to produce a fine dry powder.

### Example 49

A dispersion containing 0.5% LMP was prepared according to Example 3. 3.25 grams of LMP were dispersed in 350 grams water. Subsequently, 650 grams sucrose were added gradually to the LMP dispersion to produce a concentrated syrup. The syrup was transferred to the heated double-jacketed vessel of the vacuum dryer which was heated and maintained under vacuum according to Example 5, to produce a fine dry powder.

### Example 50

A dispersion containing 2.0% locust bean gum was prepared according to Example 3. 13.0 grams of LMP were dispersed in 350 grams water. Subsequently, 650 grams sucrose were added gradually to the locust bean gum dispersion to produce a concentrated syrup. The syrup was transferred to the heated double-jacketed vessel of the vacuum dryer which was heated and maintained under vacuum according to Example 5, to produce a fine dry powder.

### Example 51

A dispersion containing 0.1% locust bean gum was prepared according to Example 3. 0.65 grams of locust bean gum were dispersed in 350 grams water. Subsequently, 650 grams sucrose were added gradually to the locust bean gum dispersion to produce a concentrated syrup. The syrup was transferred to the heated double-jacketed vessel of the vacuum dryer which was heated and maintained under vacuum according to Example 5, to produce a fine dry powder.

### Example 52

A dispersion containing 0.6% locust bean gum was prepared according to Example 3. 3.9 grams of locust bean gum were dispersed in 350 grams water. Subsequently, 650 grams sucrose were added gradually to the locust bean gum dispersion to produce a concentrated syrup. The syrup was transferred to the heated double-jacketed vessel of the vacuum dryer which was heated and maintained under vacuum according to Example 5, to produce a fine dry powder.

### Example 53

A dispersion containing 0.1% sodium alginate was prepared according to Example 3. 0.65 grams of sodium alginate were dispersed in 350 grams water. Subsequently, 650 grams sucrose were added gradually to the sodium alginate dispersion to produce a concentrated syrup. The syrup was transferred to the heated double-jacketed vessel of the vacuum dryer which was heated and maintained under vacuum according to Example 5, to produce a fine dry powder.

### Example 54a

A dispersion containing 0.3% sodium alginate was prepared according to Example 3. 1.95 grams of sodium alginate were dispersed in 350 grams water. Subsequently, 650 grams sucrose were added gradually to the sodium alginate dispersion to produce a concentrated syrup. The syrup was transferred to the heated double-jacketed vessel of the vacuum dryer which was heated and maintained under vacuum according to Example 5, to produce a fine dry powder.

### Comparative Example 54b

A mixture containing 0.3% sodium alginate was prepared in the following manner: 1.95 grams of sodium alginate were physically mixed with 650 grams sucrose in a vessel, so as to produce a homogeneous dry mixture.

### Example 55

A dispersion containing 0.4% sodium alginate was prepared according to Example 3. 2.60 grams of sodium alginate were dispersed in 350 grams water. Subsequently, 650 grams sucrose were added gradually to the sodium alginate dispersion to produce a concentrated syrup. The syrup was transferred to the heated double-jacketed vessel of the vacuum dryer which was heated and maintained under vacuum according to Example 5, to produce a fine dry powder.

### Example 56

A dispersion containing 0.5% sodium alginate was prepared according to Example 3. 3.25 grams of sodium alginate were dispersed in 350 grams water. Subsequently, 650 grams sucrose were added gradually to the sodium alginate dispersion to produce a concentrated syrup. The syrup was transferred to the heated double-jacketed vessel of the vacuum dryer which was heated and maintained under vacuum according to Example 5, to produce a fine dry powder.

### Example 57

A dispersion containing 0.8% sodium alginate was prepared according to Example 3. 5.20 grams of sodium alginate were dispersed in 350 grams water. Subsequently, 650 grams sucrose were added gradually to the sodium alginate dispersion to produce a concentrated syrup. The syrup was transferred to the heated double-jacketed vessel of the vacuum dryer which was heated and maintained under vacuum according to Example 5, to produce a fine dry powder.

### Example 58

A dispersion containing 1.0% sodium alginate was prepared according to Example 3. 6.5 grams of sodium alginate were dispersed in 350 grams water. Subsequently, 650 grams sucrose were added gradually to the sodium alginate dispersion to produce a concentrated syrup. The syrup was transferred to the heated double-jacketed vessel of the vacuum dryer which was heated and maintained under vacuum according to Example 5, to produce a fine dry powder.

### Example 59

A dispersion containing 0.1% sodium alginate was prepared according to Example 3. 0.65 grams of sodium alginate were dispersed in 500 grams water. Subsequently, 650 grams isomalt were added gradually to the sodium alginate dispersion to produce a concentrated syrup. The syrup was transferred to the heated double-jacketed vessel of the vacuum dryer which was heated and maintained under vacuum according to Example 5, to produce a fine dry powder.

### Example 60

A dispersion containing 0.3% sodium alginate was prepared according to Example 3. 1.95 grams of sodium alginate were dispersed in 500 grams water. Subsequently, 650 grams isomalt were added gradually to the sodium alginate dispersion to produce a concentrated syrup. The syrup was transferred to the heated double-jacketed vessel of the vacuum dryer which was heated and maintained under vacuum according to Example 5, to produce a fine dry powder.

### Example 61

A dispersion containing 0.6% sodium alginate was prepared according to Example 3. 3.9 grams of sodium alginate were dispersed in 500 grams water. Subsequently, 650 grams isomalt were added gradually to the sodium alginate dispersion to produce a concentrated syrup. The syrup was transferred to the heated double-jacketed vessel of the vacuum dryer which was heated and maintained under vacuum according to Example 5, to produce a fine dry powder.

### Example 62

A dispersion containing 0.4% sodium alginate was prepared according to Example 3. 2.6 grams of sodium alginate were dispersed in 500 grams water. Subsequently, 650 grams isomalt were added gradually to the sodium alginate dispersion to produce a concentrated syrup. The syrup was transferred to the heated double-jacketed vessel of the vacuum dryer which was heated and maintained under vacuum according to Example 5, to produce a fine dry powder.

### Example 63

A dispersion containing 0.5% sodium alginate was prepared according to Example 3. 3.25 grams of sodium alginate were dispersed in 500 grams water. Subsequently, 650 grams isomalt were added gradually to the sodium alginate dispersion to produce a concentrated syrup. The syrup was transferred to the heated double-jacketed vessel of the vacuum dryer which was heated and maintained under vacuum according to Example 5, to produce a fine dry powder.

### Example 64

A dispersion containing 0.01% sodium alginate was prepared according to Example 3. 0.065 grams of sodium alginate were dispersed in 500 grams water. Subsequently, 650 grams isomalt were added gradually to the sodium alginate dispersion to produce a concentrated syrup. The syrup was transferred to the heated double-jacketed vessel of the vacuum dryer which was heated and maintained under vacuum according to Example 5, to produce a fine dry powder.

### Example 65

A dispersion containing 1.0% sodium alginate was prepared according to Example 3. 6.5 grams of sodium alginate were dispersed in 500 grams water. Subsequently, 650 grams isomalt were added gradually to the sodium alginate dispersion to produce a concentrated syrup. The syrup was transferred to the heated double-jacketed vessel of the vacuum dryer which was heated and maintained under vacuum according to Example 5, to produce a fine dry powder.

### Example 66

A dispersion containing 1.5% sodium alginate was prepared according to Example 3. 9.75 grams of sodium alginate were dispersed in 500 grams water. Subsequently, 650 grams isomalt were added gradually to the sodium alginate dispersion to produce a concentrated syrup. The syrup was transferred to the heated double-jacketed vessel of the vacuum dryer which was heated and maintained under vacuum according to Example 5, to produce a fine dry powder.

### Example 67

A dispersion containing 0.15% konjac mannan was prepared according to Example 3. 0.98 grams of konjac mannan were dispersed in 350 grams water. Subsequently, 650 grams sucrose were added gradually to the xanthan gum dispersion to produce a concentrated syrup. The syrup was transferred to the heated double-jacketed vessel of the vacuum dryer which was heated and maintained under vacuum according to Example 5, to produce a fine dry powder.

### Example 68

A dispersion containing 0.25% xanthan gum was prepared according to Example 4. After preparing a concentrated syrup containing, 350 grams water and 650 grams sucrose, 1.63 grams of the xanthan gum was introduced. The syrup was transferred to the heated double-jacketed vessel of the vacuum dryer, which was heated and maintained under vacuum according to Example 5, to produce a fine dry powder.

### Example 69

A dispersion containing 0.25% xanthan gum was prepared according to Example 6. A concentrated syrup containing 350 grams water and 650 grams sucrose was prepared in a first step. Subsequently, a pre-dispersion of 1.63 grams of xanthan gum dispersed in a small quantity of water was introduced to the concentrated syrup. Upon heating and vacuum the water gradually evaporated, producing a powder. The powder was transferred to an oven operating at 65° C. for further drying overnight.

### Example 70

A dispersion containing 1.0% xanthan gum was prepared according to Example 4. After preparing a concentrated syrup containing, 350 grams water and 650 grams sucrose, 6.5 grams of the xanthan gum was introduced. The syrup was transferred to the heated double-jacketed vessel of the vacuum dryer, which was heated and maintained under vacuum according to Example 5, to produce a fine dry powder.

### Example 71

A dispersion containing 1.0% xanthan gum was prepared according to Example 6. A concentrated syrup containing 350 grams water and 650 grams sucrose was prepared in a first step. Subsequently, a pre-dispersion of 6.5 grams of xanthan gum dispersed in a small quantity of water was introduced to the concentrated syrup. Upon heating and vacuum the water gradually evaporated, producing a powder. The powder was transferred to an oven operating at 65° C. for further drying overnight.

### Example 72

A dispersion containing 0.15% konjac mannan was prepared according to Example 4. After preparing a concentrated syrup containing, 350 grams water and 650 grams sucrose, 0.98 grams of the konjac mannan was introduced. The syrup was transferred to the heated double-jacketed vessel of the vacuum dryer, which was heated and maintained under vacuum according to Example 5, to produce a fine dry powder.

### Example 73

A dispersion containing 0.5% konjac mannan was prepared according to Example 6. A concentrated syrup containing 350 grams water and 650 grams sucrose was prepared in a first step. Subsequently, a pre-dispersion of 3.25 grams of konjac mannan was dispersed in a small quantity of water. The pre-dispersion was then introduced to the concentrated syrup. Upon heating and vacuum the water gradually evaporated, producing a powder. The powder was transferred to an oven operating at 65° C. for further drying overnight.

### Example 74a

### Preparation of Petit Beurre Biscuit Samples

Two novel petit beurre biscuit samples having reduced sugar content are prepared, both having 40 wt% less sugar with respect to typical commercially available biscuits. Since the full (non-reduced) sugar petit beurre biscuit batter contains 16.5 wt% sugar, each of the two petit beurre biscuit batters described below is formulated to contain about (100%-40%) •16.5% = 9.9 wt% sugar.

The biscuit batters also contain 10.6% palm oil and 59% wheat flour (approximately 40% starch). The biscuit batters also contain about 13% water.

Inulin (about 6.6 wt% of the formulation, on a wet basis) is used as a filler to make up the reduced amount of sugar in both samples (16.5% - 9.9% = 6.6 wt% inulin). Typically, Orafti Highly Soluble Inulin is utilized.

The second petit beurre batter utilizes a sweetener formulation from various exemplary formulations (described hereinabove) containing a minute amount of polysaccharide (e.g., as a mucoadhesive agent). The baked product is referred to as a “PS Biscuit”. The first petit beurre batter (baked to produce a “Control Biscuit”) is a comparative sample, devoid of the polysaccharide in the sweetener formulation. Thus, the recipes are substantially identical except for this minute amount of polysaccharide. The preparation process is also identical.

### Example 74b

### Preparation of Butter Cookie Samples

Two novel butter cookie samples having reduced sugar (typically sucrose) content are prepared, both having approximately 45 wt% less sugar with respect to typical commercially available butter cookies. Since the full sugar (i.e., non-reduced) butter cookie batter contains 19 wt% sugar, each of the two butter cookie batters described below is formulated to contain about (100%-45%) •19% = 10.5 wt% sugar.

Inulin (about 8.5 wt% of the formulation) is used as a filler to make up the reduced amount of sugar in both samples (19% - 10.5% = 8.5 wt% inulin). Typically, Orafti Highly Soluble Inulin is utilized.

The other ingredients are palm oil (14.5%), wheat flour (49%), corn starch (4.2%), egg (3.7%), with water being the remainder.

The second butter cookie batter utilizes a sweetener formulation from various exemplary formulations (described hereinabove) containing a minute amount of polysaccharide (e.g., as a mucoadhesive agent). The baked product thereof is referred to as a “PS Cookie”. The first butter cookie batter (baked to produce a “Control Cookie”) is a comparative sample, devoid of the polysaccharide in the sweetener formulation. Thus, the recipes are substantially identical except for this minute amount of polysaccharide. The preparation process is also identical.

### Example 74c

### Taste Evaluation

The samples prepared according to Examples 74A and 74B are evaluated by trained sensory panelists using a paired-comparison test. The test is a two-product blind test, and the panelists’ task is to choose/indicate the sweeter one of the two products (samples). This method is also known as a directional paired-comparison test, with the “directional” component alerting the subject to a specific type of paired test (Sensory Evaluation Practices, 4^{th} Ed., Stone, Bleibaum, Thomas, eds.).

A Comparative Sweetness Index was calculated from the paired-comparison test results, compiled from all the panelists. For example, if, among 17 panelists, 10 chose the Inventive Biscuit as being sweeter, while the other 7 panelists chose the comparative biscuit, the Comparative Sweetness Index (CSI) would be calculated as:

$$\text{CSI} \text{=} \left(10 / 17\right) \cdot 100 = 58.8 = \text{} 59 \left(\text{rounded}\right)$$

### Example 74d

Another sensory method used to evaluate samples is difference magnitude estimation (DME). Here, each panelist tastes the two samples, choose the sweetest, and also chooses the difference in sweetness, from the following list:
No difference at all
Extremely small difference
Small difference
Moderate difference
Large difference
Extremely large difference
Each choice is given a numerical value (0-5), and the average of the panel is calculated (when the first (inventive, protein-containing) sample is indicated as sweeter, the values are taken as positive, and vice versa). Generally, a difference of up to ±1.0 (i.e., within an absolute value of 1), and in some cases, up to ±0.8 or up to ±0.5, is considered to be insignificant (i.e., the sweetness of the samples is substantially the same). An insignificant difference is considered to be a good result for the inventive formulation vs. the control formulation.

### Examples 75-77

The formulations disclosed in Examples 7-9 were used to prepare Petit Beurre Biscuit Samples, according to Example 74A.

Pair-comparison test results of the pair-comparison tests, performed and evaluated according to Example 74C, are listed below in Table 1.

TABLE 1

| % Xanthan Gum in Biscuit | Comparative Sweetness Index (CSI) |
|---|---|
| 0.15 | 62 |
| 0.25 | 75 |
| 1.00 | 38 |

The results show that at a xanthan gum concentration of only 0.25% in the inventive sweetener formulation, 75% of the tasters identify the PS biscuit of the present invention as being sweeter than the control biscuit that is devoid of the xanthan gum within the sugar particles, but is otherwise identical to the biscuit of the present invention.

FIG. 1 is a graph plotting the comparative sweetness index for these three trials.

### Examples 78-81

The formulations disclosed in Examples 46-49 were used to prepare Petit Beurre Biscuit Samples, according to Example 74A.

Pair-comparison test results of the pair-comparison tests, were performed and evaluated according to Example 74C and Example 74D. The Comparative Sweetness Index for each of Examples 46-49 is provided in Table 2.

TABLE 2

| % Pectin (LMP) in Biscuit | Comparative Sweetness Index (CSI) |
|---|---|
| 0.05 | 50 |
| 0.10 | 82 |
| 0.50 | 64 |
| 1.00 | 64 |

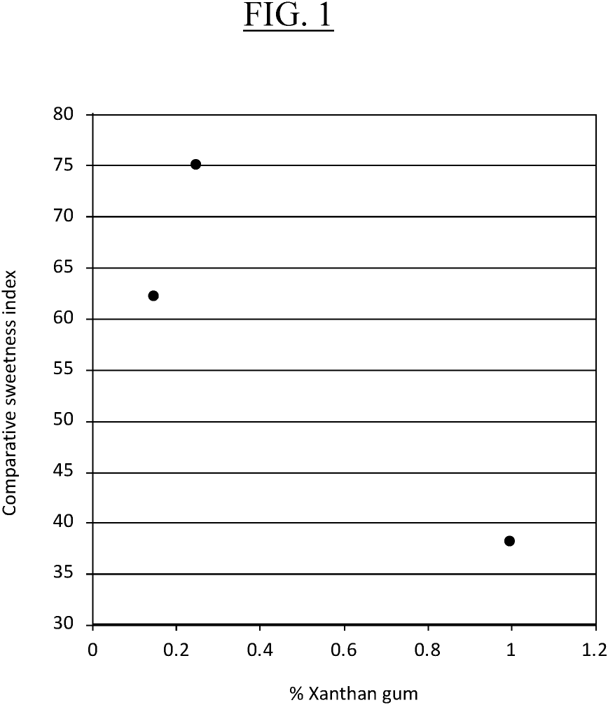

FIG. 2 is a graph plotting the comparative sweetness index for these four trials.

### Examples 81a and Comparative Example 81b

The formulations disclosed in Example 54A and Comparative Example 54B were used to prepare Butter Cookie Samples (PS Cookies) and Control Cookies, according to Example 74B.

Pair-comparison test results of the pair-comparison tests were performed and evaluated according to Example 74C. The Comparative Sweetness Index for each of Example 54A and Comparative Example 54B was evaluated with respect to the Control Cookie. The results are plotted in FIGS. 2A and 2B.

### Examples 82-87

The formulations disclosed in Examples 53-58 were used to prepare Petit Beurre Biscuit Samples, according to Example 74A.

Pair-comparison test results of the pair-comparison tests, performed and evaluated according to Example 74C and Example 74D. The Comparative Sweetness Index for each of Examples 53, 54A, and 55-58 is provided in Table 3.

TABLE 3

| % Sodium Alginate in Biscuit | Comparative Sweetness Index (CSI) |
|---|---|
| 0.10 | 54 |
| 0.30 | 64 |
| 0.40 | 67 |
| 0.50 | 62 |
| 0.80 | 55 |
| 1.00 | 45 |

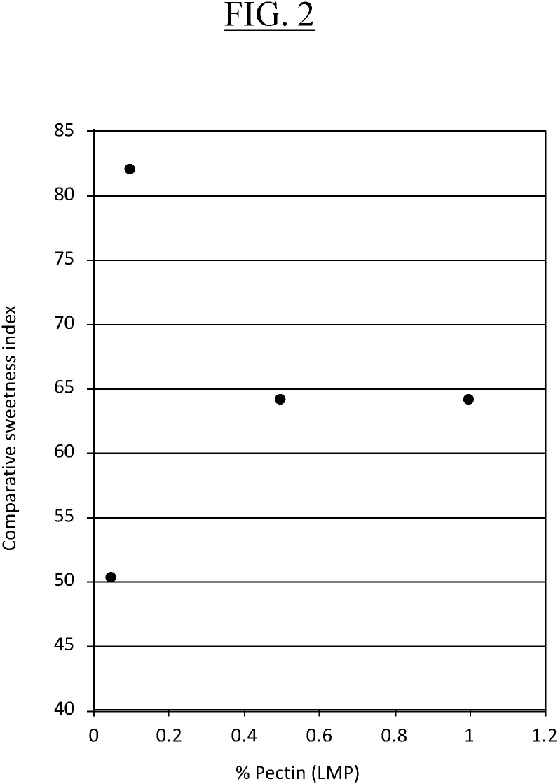

FIG. 3 is a graph plotting the comparative sweetness index for these six trials. The results show that at a sodium alginate concentration within a range of 0.30% to 0.50% in the inventive sweetener formulation, over 60% of the tasters identify the PS biscuit of the present invention as being sweeter than the control biscuit that is devoid of the sodium alginate within the sugar particles, but is otherwise identical to the PS biscuit of the present invention.

### Examples 88-90

The formulations disclosed in Examples 21-23 were used to prepare Petit Beurre Biscuit Samples, according to Example 74A.

Pair-comparison test results of the pair-comparison tests, performed and evaluated according to Example 74C and Example 74D. The Comparative Sweetness Index for each of Examples 21-23 is provided in Table 4.

TABLE 4

| % Agar-Agar in Biscuit | Comparative Sweetness Index (CSI) |
|---|---|
| 0.04 | 40 |
| 0.10 | 69 |
| 1.20 | 62 |

The results show that at an agar-agar concentration of only 0.10% in the inventive sweetener formulation, 69% of the tasters identify the PS biscuit of the present invention as being sweeter than the control biscuit that is devoid of the agar-agar within the sugar particles, but is otherwise identical to the PS biscuit of the present invention.

Moreover, even at a relatively high concentration of agar-agar - 1.20%, the inventive sweetener formulation is perceived by 62% of the tasters to be sweeter that the control.

More generally, Examples 75-90 show that relatively low concentrations (typically less than 1%, on a 100% sweetener basis) of the mucoadhesive polysaccharide are effective in enhancing the sweetness sensation of the food; that within this narrow range of concentrations, the efficacy of the sweetness enhancement is highest within an intermediate range of concentrations. Surprisingly, at polysaccharide concentrations above this intermediate range, the efficacy of the sweetness enhancement does not increase further, and actually drops, often appreciably.

### Example 91

### Tensile Strength/Detachment Force-Texture Analysis

The mucoadhesion properties of sweetener formulations were evaluated by performing detachment tests using the TA.XTplus Texture Analyzer. The effect of various mucoadhesive polysaccharides on the adhesiveness of the sweetener formulation was also investigated, at various concentrations.

### Materials and Methods

Before the detachment tests were executed, the following steps were performed: tablet preparation from sugar samples, preparation of artificial saliva buffer solution and trimming of fresh pig tongues to pieces of 30 mm × 30 mm with thickness of around 20 mm. The tongue tissues were frozen at -20° C. Before the test, tongue tissue was heated to 37° C. for 5 minutes. In terms of artificial saliva, the solution was prepared according to the following composition (Table 5):

TABLE 5

Artificial Saliva Composition

| | |
|---|---|
| NaHCO₃ | 2.5 mM |
| KCl | 10 mM |
| NaCl | 7.4 mM |
| CaCl₂ | 1.5 mM |
| NaH₂PO₄ | 5.8 mM |

### Tablet Preparation

Tablets, made from the sweetener samples listed in Table 7 provided hereinbelow, were prepared for detachment test using the Tableting Minipress MII machine. “Dry Mix” samples were ground and mixed with magnesium stearate (as a lubricant) at 2 w/w% in a Tumble Mixer for 2 minutes. The mixture was introduced to the Minipress and pressed at an upper punch penetration of 11 mm, to produce flat tablets. The sweetener samples, produced according to Example 3 and dried according to Example 5, were pressed at a lower upper punch penetration of 7.5 - 9 mm. For all samples, the preparation rate was around 40 tablets/minute in automatic mode. The diameter of the tablet is 10 mm.

### Detachment Tests

The trimmed pig tongue piece was pressure-fixed between a plastic platform and a lid, by means of four screws. A hole (13 mm in diameter), disposed in the middle of the lid, enables tablet-tongue contact. The plastic platform and pig tongue arrangement was maintained in the artificial saliva solution under constant temperature of 37° C. A sweetener tablet was attached to the Texture Analyzer (TA) probe (cylinder) by means of a double-sided adhesive tape. The measurement was performed using the following procedure: the probe, together with the tablet, was lowered at constant speed until a pre-determined applied force was exerted, for a fixed contact time, with the tongue tissue. Once finished, the probe and tablet were lifted, and the (maximum) detachment force (Fₘₐₓ) and detachment work (area between the curve and X-axis, also termed “total work of adhesion”) were recorded for each of the sweetener tablets. The whole process was controlled by the TA adhesion test rig, utilizing the settings provided in Table 6.

TABLE 6

Measurement conditions for the detachment tests

| | |
|---|---|
| Pre-test speed | 0.5 mm/s |
| Test speed | 0.5 mm/s |
| Post-test speed | 0.1 mm/s |
| Applied force | 200 gr |
| Return distance | 5.0 mm |
| Contact time | 40 sec |
| Trigger force | 5.0 gr |
| Saliva buffer amount | 100 µL |

As used herein, the above-described detachment test procedure is referred to as a “standard detachment test”.

### Examples 92-95

Four sweetener samples, provided in Table 7 below, were formulated and tabletized using the equipment and procedures disclosed in Example 91.

TABLE 7

Sweetener samples for the detachment tests

| Sweetener samples | Mucoadhesive agent | Mucoadhesive agent concentration (%) | Preparation Method |
|---|---|---|---|
| Control sample: Sucrose (100%) | None | 0 | Grinding |
| Comparative sample I | Sodium alginate | 5.0 | Dry Mix |
| Sample II | Sodium alginate | 5.0 | Fully Dispersed (Example 3) + Vacuum Cryst. (Example 5) |
| Sample III (Formulation of Example 58) | Sodium alginate | 1.0 | |

The control sample (Example 92) consists of pure sucrose and was prepared by grinding.

Comparative sample I (Example 93) contains a polysaccharide, sodium alginate, as a mucoadhesive agent in a weight ratio of 5% with respect to the sucrose (i.e., a 1:20 ratio), and was prepared by dry mixing.

Sample II (Example 94) has the identical composition to Comparative sample I but was prepared by the methods of the present invention - producing a full dispersion followed by evaporative crystallization and vacuum drying (as described in Examples 3 and 5 hereinabove).

Sample III (Example 95) was prepared by the methods of the present invention, in a manner identical to that of Sample II. However, Sample III contains only 1% sodium alginate, i.e., a 1:100 weight ratio with respect to the sucrose.

### Examples 96-99

Tablets of the four sweetener samples (produced in Examples 92-95) were evaluated to determine the maximum detachment force and the work of detachment, using the equipment and procedures disclosed in Example 91.

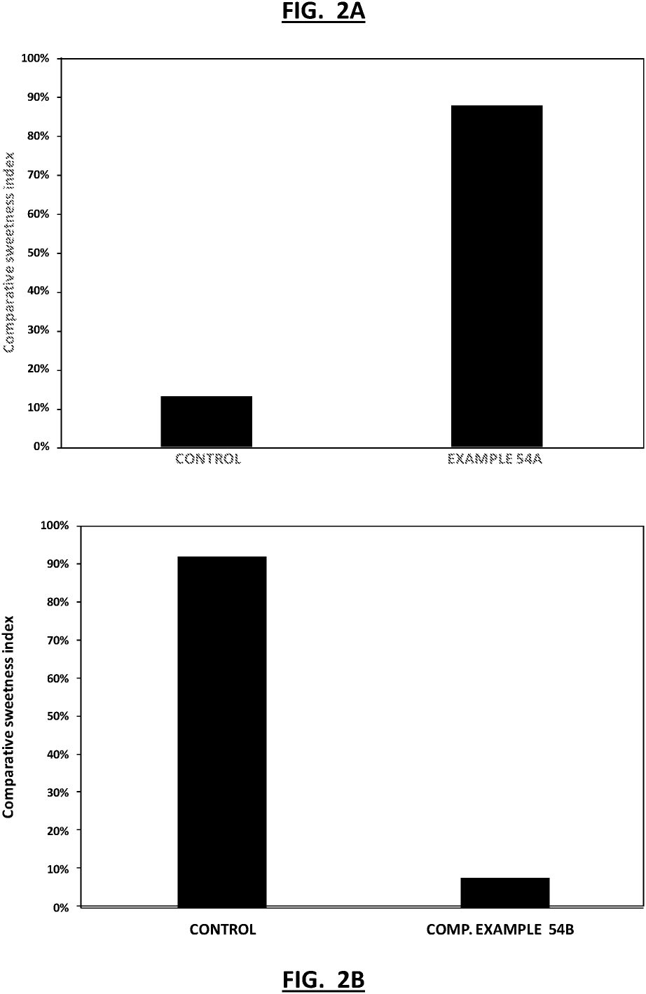

A comparative bar graph plotting the maximum detachment force required for the first three of these four sweetener formulations, as characterized by the texture analyzer, is provided in FIG. 4.

The maximum required force for the sucrose control sample was 0.87 grams. Comparative sample I, which contained 5% sodium alginate, and was prepared by dry mixing, attained a maximum force of 1.51 grams, an increase of over 70% with respect to the sucrose control sample. Surprisingly, sample II, which also contained 5% sodium alginate, but was prepared by the above-described methods of the present invention, attained a maximum force of about 3.5 grams, an increase of about 300% with respect to the sucrose control sample, and an increase of about 130% with respect to Comparative sample I having the identical composition.

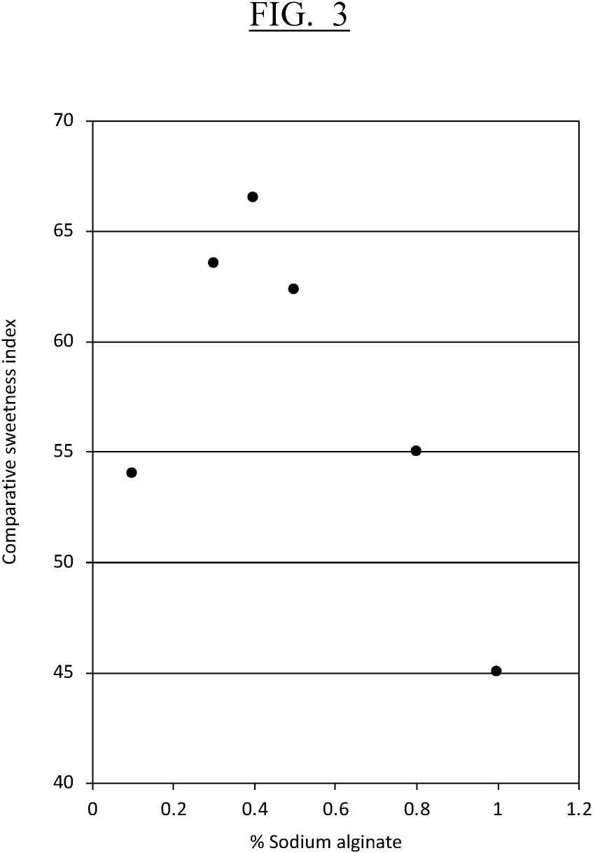

Qualitatively similar results were obtained from the work of detachment characterization. A comparative bar graph plotting the detachment work required for these sweetener formulations, is provided in FIG. 5.

The work of detachment for the sucrose control sample was about 9.8 gram-mm. Comparative sample I, which contained 5% sodium alginate, and was prepared by dry mixing, had a work of detachment of 15.8 gram-mm, an increase of over 60% with respect to the sucrose control sample. Sample II, which also contained 5% sodium alginate, but was prepared by the above-described methods of the present invention, had a work of detachment of 29.0 gram-mm, an increase of over 190% with respect to the sucrose control sample, and an increase of over 80% with respect to Comparative sample I having the identical composition.

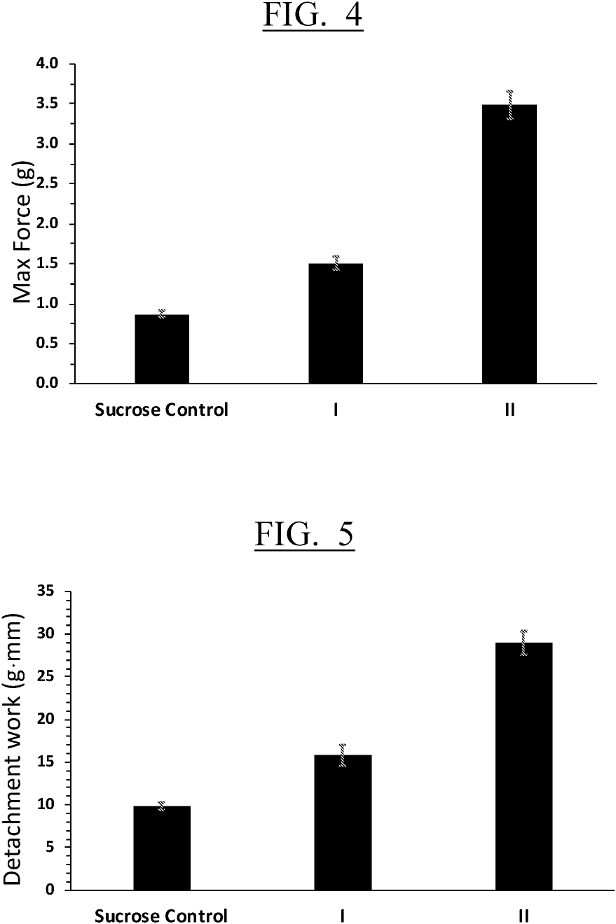

With reference now to FIG. 6, FIG. 6 is a comparative bar graph plotting the maximum detachment force required for inventive Sample III, as compared to the maximum detachment force required for Sample II and for the pure sucrose control sample. Sample III, a sweetener formulation containing 1% sodium alginate and prepared in accordance with the methods of the present invention, had a maximum force requirement of 0.98 grams, about 12% (or 0.11 grams) higher than the requirement for the pure sucrose control sample.

It is evident that the mucosal adhesion of the sweetener formulation, as characterized by the maximum detachment force, is greater than that of the control composition, (i.e., a formulation being devoid of the polysaccharide, but being otherwise identical to the sweetener formulation in both composition and preparation method). Typically, the mucosal adhesion of the sweetener formulation, as characterized by the maximum detachment force, is greater than that of the control composition by at least 1%, at least 1.5%, at least 2%, at least 3%, or at least 4%, and in some cases, at least 5%, at least 7%, at least 10%, at least 12%, or at least 15%.

The inventors have further discovered that at relatively high levels of mucosal adhesion (e.g., as characterized by at least one of the maximum detachment force and the work of detachment), the presence of the polysaccharide may actually be detrimental to the sweetness of the food or formulation, as perceived by taste-testing.

Thus, in some embodiments, the mucosal adhesion of the sweetener formulation, as characterized by the maximum detachment force, is greater than that of the control composition by at most 200%, at most 150%, at most 100%, at most 80%, and more typically, at most 60%, at most 50%, at most 40%, at most 35%, or at most 30%.

In some embodiments, the mucosal adhesion of the sweetener formulation, as characterized by the maximum detachment force, is greater than that of the control composition by a value within a range of 1% to 200%, 1% to 120%, 1% to 80%, 1% to 60%, 1% to 40%, 1% to 30%, 1% to 25%, 1% to 20%, 1.5% to 60%, 1.5% to 40%, 1.5% to 30%, 1.5% to 25%, 1.5% to 20%, 2% to 200%, 2% to 120%, 2% to 80%, 2% to 60%, 2% to 50%, 2% to 40%, 2% to 30%, 2% to 25%, 2% to 20%, 3% to 80%, 3% to 60%, 3% to 40%, 3% to 30%, 3% to 25%, 3% to 20%, 4% to 60%, 4% to 40%, 4% to 30%, 4% to 25%, 4% to 20%, 5% to 60%, 5% to 40%, 5% to 30%, 5% to 25%, 5% to 20%, 6% to 60%, 6% to 40%, 6% to 30%, 6% to 25%, 6% to 20%, 8% to 50%, 8% to 30%, 8% to 25%, or 8% to 20%.

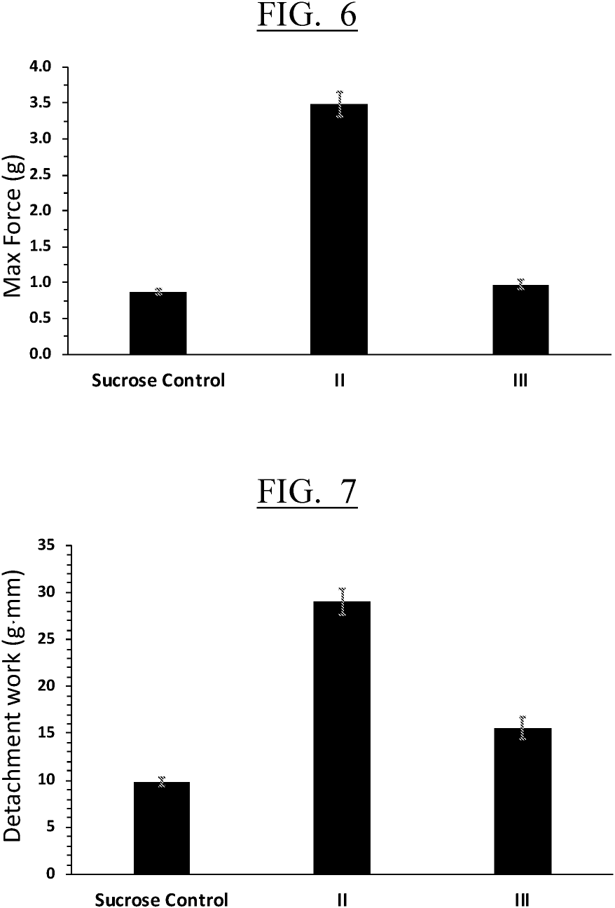

FIG. 7 is a comparative bar graph plotting the work of detachment required for the sweetener formulations described with reference to FIG. 6. The work of detachment for inventive Sample III was about 15.6 gram-mm. This exceeds the work of detachment for the sucrose control sample by about 5.8 gram-mm (about 60%).

It is evident that the mucosal adhesion of the sweetener formulation, as characterized by the work of detachment, is greater than that of the control composition, (i.e., as above, a formulation being devoid of the polysaccharide, but being otherwise identical to the sweetener formulation in both composition and preparation method). Typically, the mucosal adhesion of the sweetener formulation, as characterized by the work of detachment, is greater than that of the control composition by at least 1%, at least 1.5%, at least 2%, at least 3%, at least 5%, at least 10%, at least 20%, at least 30%, at least 40%, or at least 45%.

In some embodiments, the mucosal adhesion of the sweetener formulation, as characterized by the work of detachment, is greater than that of the control composition by at most 200%, at most 150%, at most 125%, at most 110%, at most 100%, at most 90%, at most 80%, at most 70%, at most 60%, or at most 50%.

In some embodiments, the mucosal adhesion of the sweetener formulation, as characterized by the work of detachment, is greater than that of the control composition by a value within a range of 10% to 150%, 10% to 125%, 10% to 100%, 10% to 80%, 20% to 150%, 20% to 125%, 20% to 100%, 20% to 80%, 30% to 150%, 30% to 125%, 30% to 100%, 30% to 80%, 40% to 150%, 40% to 125%, 40% to 100%, 40% to 80%, 50% to 150%, 50% to 125%, 50% to 100%, or 50% to 90%.

In some embodiments, the mucosal adhesion of the sweetener formulation, as characterized by the maximum detachment force, is greater than that of the control composition by a value within a range of 1% to 200%, 1% to 150%, 1% to 120%, 1% to 80%, 1% to 60%, 1% to 40%, 1% to 30%, 1% to 25%, 1% to 20%, 1.5% to 60%, 1.5% to 40%, 1.5% to 30%, 1.5% to 25%, 1.5% to 20%, 2% to 200%, 2% to 120%, 2% to 80%, 2% to 60%, 2% to 40%, 2% to 30%, 2% to 25%, 2% to 20%, 3% to 80%, 3% to 60%, 3% to 40%, 3% to 30%, 3% to 25%, 3% to 20%, 4% to 60%, 4% to 40%, 4% to 30%, 4% to 25%, 4% to 20%, 5% to 60%, 5% to 40%, 5% to 30%, 5% to 25%, 5% to 20%, 6% to 60%, 6% to 40%, 6% to 30%, 6% to 25%, 6% to 20%, 8% to 50%, 8% to 30%, 8% to 25%, 8% to 20%, 10% to 150%, 10% to 125%, 10% to 100%, 10% to 80%, 20% to 150%, 20% to 125%, 20% to 100%, 20% to 80%, 30% to 150%, 30% to 125%, 30% to 100%, 30% to 80%, 40% to 150%, 40% to 125%, 40% to 100%, 40% to 80%, 50% to 150%, 50% to 125%, 50% to 100%, or 50% to 90%.

As used herein in the specification and in the claims section that follows, the term “maximum detachment force” (F_{Dmax}) refers to the maximum detachment force as measured by the standard detachment test.

As used herein in the specification and in the claims section that follows, the term “detachment work” (W_{D}) refers to the work of detachment as measured by the standard detachment test.

As used herein in the specification and in the claims section that follows, the term “work of detachment determination” (W_{D-D}) for a sweetener formulation containing a particular polysaccharide within the sweetener particles thereof, refers to the work of detachment for the identical polysaccharide-containing sweetener formulation, but having a concentration of 1% of that particular polysaccharide with respect to the sweetener, and prepared and measured according to the standard procedure of Example 91, the obtained detachment work (W_{D}) then being linearly applied using a coefficient K_{conc} based on the actual concentration (C_{actual}), in %, of that particular polysaccharide disposed within the sweetener particles of the formulation. Similarly, as used herein in the specification and in the claims section that follows, the term “maximum force of detachment determination” (F_{D-D}) for a sweetener formulation containing a particular polysaccharide within the sweetener particles thereof, refers to the maximum detachment force (F_{Dmax}) for the identical polysaccharide-containing sweetener formulation, but having a concentration of 1% of that particular polysaccharide with respect to the sweetener, and prepared and measured according to the standard procedure of Example 91, the obtained maximum detachment force (F_{Dmax}) then being linearly applied using a coefficient K_{conc} based on the actual concentration (C_{actual}), in %, of that particular polysaccharide disposed within the sweetener particles of the formulation. Thus:

$${\text{K}}_{\text{conc}} \text{=} {\text{C}}_{\text{actual}} / \text{1\%}$$

$${\text{F}}_{\text{D-D}} \text{=} {\text{K}}_{\text{conc}} \cdot {\text{F}}_{\text{Dmax}}$$

$${\text{W}}_{\text{D-D}} \text{=} {\text{K}}_{\text{conc}} \cdot {\text{W}}_{\text{D}}$$

As used herein in the specification and in the claims section that follows, the term “mucosal adhesion” and the like, with respect to a formulation, is meant to refer to mucosal adhesion as exhibited by at least one of maximum detachment force (F_{Dmax}), maximum force of detachment determination (F_{D-D}), detachment work (W_{D}), and work of detachment determination (W_{D-D}).

### Example 100

### Rheological Characterization of Mucoadhesivity

The mucoadhesive properties of various polysaccharides were characterized using rheological measurements. It is known that the rheological behavior of the mixture containing the mucoadhesive polysaccharides and mucin may be appreciably influenced by chemical interactions, conformational changes and chain interlocking between the two species. Rheological techniques are used to study the deformation of material and their flow behavior under shear. Such measurement allows monitoring the interactions between polymers (Hassan and Gallo, 1990). Interactions between the mucoadhesive polysaccharide macromolecules and the mucin are manifested by viscosity enhancement, such that the viscosity of the mixture exceeds the sum of the individual viscosities of the mucin and the polysaccharide. Thus, by measuring the individual viscosities, along with the viscosity of the mucin - polysaccharide mixture, the mucoadhesiveforce between the mucin and the polysaccharide may be characterized, according to the following equation:

$$η \text{t=} η \text{m+} η \text{p+} η \text{b}$$

where ηt is the total (measured) viscosity of the system (mixture), ηb is the viscosity component of bioadhesion (viscosity enhancement), ηm and ηp are the individually-measured viscosities of mucin and polysaccharide single-component dispersions, respectively.

Various polysaccharide dispersions of 2 wt% in distilled water were prepared according to the manufacturer instructions and were gently mixed for 3 hours. Dried mucin was hydrated with distilled water (sufficient to make a 10 wt% dispersion) by gentle stirring for 1 hour at room temperature followed by sonication of 10 minutes (at room temperature). The mucin solution was then gently stirred for 2 hours to yield the 10 wt% mucin dispersion. Equal amounts of each polysaccharide dispersion and the 10 wt% mucin dispersion were mixed to yield a final concentration of 1 wt% polysaccharide and 5 wt% mucin for each mixed dispersion. All mixture systems were maintained at 37° C. for 1 hour to equilibrate prior to analysis.

All measurements were performed using the Anton Paar MRC92 rheometer having a Peltier temperature chamber: C-PTD 180/air, rotating bob (CC27 concentric cylinder) and a fixed cup (C-CC27/SS/AIR) having a diameter of 28.992 mm.. Prior to the measurement, each sample formulation was allowed to rest for another 2 minutes. The measurements were performed at 37° C. at a shear rate ranging between 0.1-350 s⁻¹ (logarithmic ramp).

Measurements for each polysaccharide (1 wt%) dispersion and for a 5 wt% mucin dispersion were performed in order to yield the individual viscosities (ηp, ηm). The enhanced viscosity (bioadhesion) was then calculated for each polysaccharide-mucin, according to the above-provided equation.

### Examples 101-104

The mucoadhesive properties of four samples were characterized using the rheological equipment and methodology provided in Example 100. All five samples contained 5% mucin, by weight. In addition, Example 101 contained 1% pectin (HMP); Example 102 contained 1% sodium alginate; Example 103 contained 1% pectin (LMP); and Example 104 contained 1% guar gum.

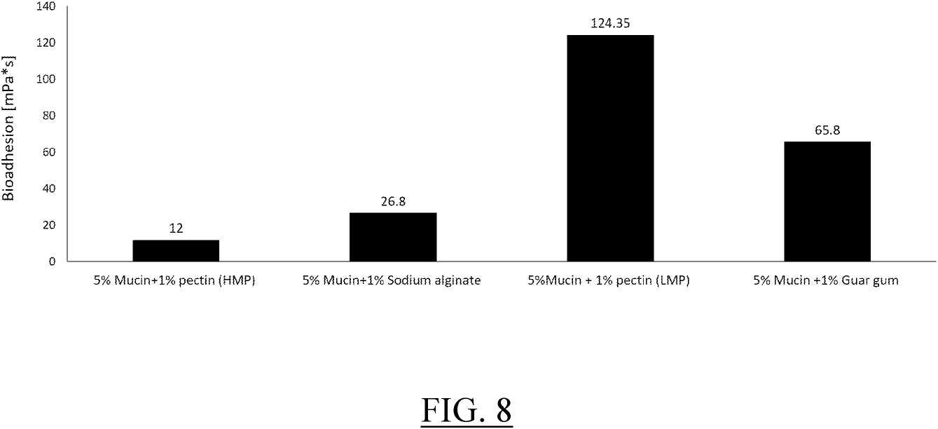

FIG. 8 is a comparative bar graph plotting the calculated bioadhesion between various formulations containing 1% of a potentially mucoadhesive ingredient and a 5% mucin preparation, based on the above-described rheological measurements.

All four samples (Examples 101-104) exhibited appreciable bioadhesion, each having a positive bioadhesion viscosity component (ηb) within a range of 10 to 125 mPa•s.

Based upon these exemplary results, as well as upon other experimental results pertaining to bioadhesion, it may be stated that a polysaccharide can be considered to be mucoadhesive, or to be a mucoadhesive agent, if the bioadhesion viscosity component (ηb), as measured according to the standard procedure of Example 100, at a polysaccharide concentration of 1%, is at least 3 mPa•s. More typically, ηb is at least 5 mPa•s, at least 7 mPa•s, or at least 10 mPa•s. As used herein in the specification and in the claims section that follows, this determination of mucoadhesivity (i.e., whether the polysaccharide is considered to be mucoadhesive, or to be a mucoadhesive agent) is referred to as a “standard rheological determination”.

Typically, this bioadhesion viscosity component (ηb) is within a range of 3-200 mPa•s, 3-150 mPa•s, 5-200 mPa•s, 5-150 mPa•s, 6-200 mPa•s, 6-150 mPa•s, 7-200 mPa•s, 7-150 mPa•s, 8-200 mPa•s, 8-150 mPa•s, 10-200 mPa•s, 10-150 mPa•s, 10-100 mPa•s, 12-200 mPa•s, 12-150 mPa•s, 15-200 mPa•s, 15-150 mPa•s, 20-200 mPa•s, 20-150 mPa•s, or 20-100 mPa•s.

As used herein in the specification and in the claims section that follows, the term “bioadhesive concentration of polysaccharide” and the like refers to a particular concentration of at least one polysaccharide disposed within the sweetener particles of a formulation, the particular concentration of the at least one polysaccharide being sufficient to attain a value of at least 3 mPa•s for a bioadhesion viscosity component (ηb), as measured according to the standard procedure of Example 100, but at that particular concentration.

As used herein in the specification and in the claims section that follows, the term “bioadhesive content of polysaccharide” and the like, with respect to a polysaccharide-containing formulation, refers to an actual concentration (C_{actual}) of at least one polysaccharide disposed within the sweetener particles of the formulation, said actual concentration being sufficient to attain a bioadhesion viscosity increase (Δη_{PS}) of at least 1.0 mPa•s, wherein the bioadhesion viscosity component (ηb) is measured according to the standard procedure of Example 100 at a concentration of 1% polysaccharide, and then linearly applied to obtain Δη_{PS} using a coefficient K_{conc} based on the actual concentration (C_{actual}), in %, of the at least one polysaccharide disposed within the sweetener particles of the formulation:

$${\text{K}}_{\text{conc}} \text{=} {\text{C}}_{\text{actual}} / \text{1\%}$$

$$\text{bioadhesion} \text{viscosity} \text{increase} \left(Δ {η}_{\text{PS}}\right) = {\text{K}}_{\text{conc}} \cdot η \text{b}$$

Thus, when the bioadhesion viscosity increase (Δη_{PS}) is at least 1.0 mPa•s for C_{actual}, the formulation is deemed to have a bioadhesive content of polysaccharide.

As used herein in the specification and in the claims section that follows, the terms “bioadhesive formulation”, “bioadhesive sweet formulation” and the like refer to a formulation containing at least one of a bioadhesive concentration of polysaccharide and a bioadhesive content of polysaccharide.

### Example 105

The formulation of Example 54A, containing 0.3% sodium alginate, was evaluated for bioadhesivity in terms of “bioadhesive content of polysaccharide”. As elaborated in Example 102, the formulation containing 1.0% sodium alginate achieved a bioadhesion of 26.8 mPa•s. This value is linearly applied using the coefficient K_{conc}, which equals 0.3 (0.3%/1%). The bioadhesion viscosity increase (Δη_{PS}), from Equation II above, equals K_{conc}• ηb = 8.04 mPa•s (0.3 • 26.8 mPa•s). As this value exceeds the cutoff threshold of 1.0 mPa•s, the 0.3% sodium alginate formulation of Example 60 has a bioadhesive content of polysaccharide.

### Example 106

A dispersion containing 0.1% sodium alginate and 0.15% pectin (HMP) was prepared according to Example 3. 0.65 grams of sodium alginate and 0.98 grams of the pectin were dispersed in 350 grams water. Subsequently, 650 grams sucrose were added gradually to the mixed polysaccharide dispersion to produce a concentrated syrup. The syrup was transferred to the heated double-jacketed vessel of the vacuum dryer which was heated and maintained under vacuum according to Example 5, to produce a fine dry powder.

### Example 107

The formulation of Example 106, containing 0.1% sodium alginate and 0.15% HMP, was evaluated for bioadhesivity in terms of “bioadhesive content of polysaccharide”. As elaborated in Examples 102-103, the formulation containing 1.0% sodium alginate achieved a bioadhesion of 26.8 mPa•s and the the formulation containing 1.0% HMP achieved a bioadhesion of 12 mPa•s. These values are linearly applied using the respective coefficients K_{conc}, as follows to obtain the total bioadhesion viscosity increase (Δη_{PS}):

$${\text{K}}_{\text{conc}} = 0.1 \text{for} \text{sodium} \text{alginate} \left(0.1 \% / 1 \%\right) ;$$

$${\text{K}}_{\text{conc}} = 0.15 \text{} \text{for} \text{HMP} \left(0.15 \% / 1 \%\right) ;$$

$$\left(Δ {η}_{\text{PS}}\right) = 0.1 \cdot 26.8 \text{mPa} \cdot \text{s} \text{+} \text{0} \text{.15} \cdot \text{12} \text{mPa} \cdot \text{s} \text{=} \text{4} \text{.48} \text{mPa} \cdot \text{s} \text{.}$$

As Δη_{PS} exceeds the cutoff threshold of 1 mPa•s, the formulation of Example 106 has a bioadhesive content of polysaccharide.

### Example 108

A pure sucrose control sample and a 1% xanthan gum formulation (prepared according to Example 9) were tabletized and characterized using the equipment and procedures disclosed in Example 91.

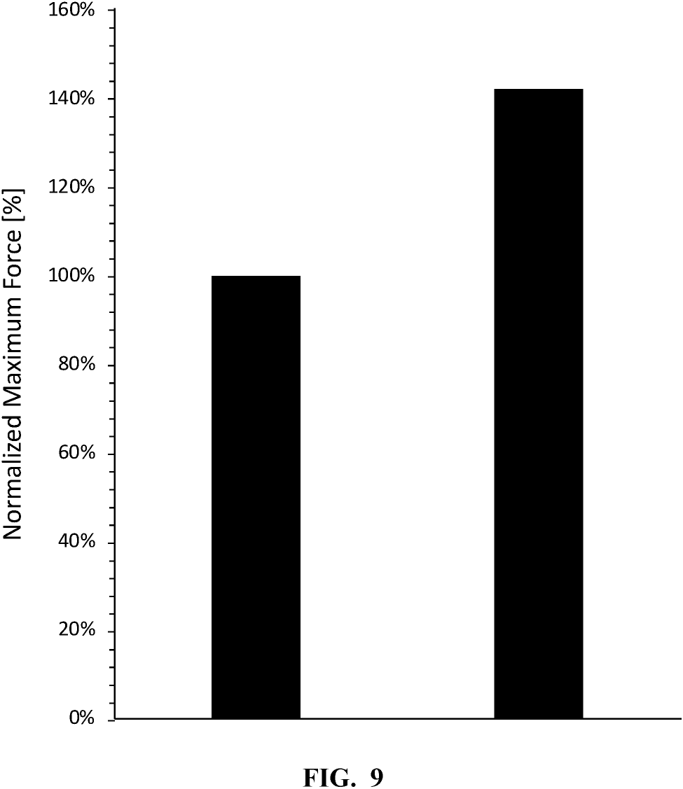

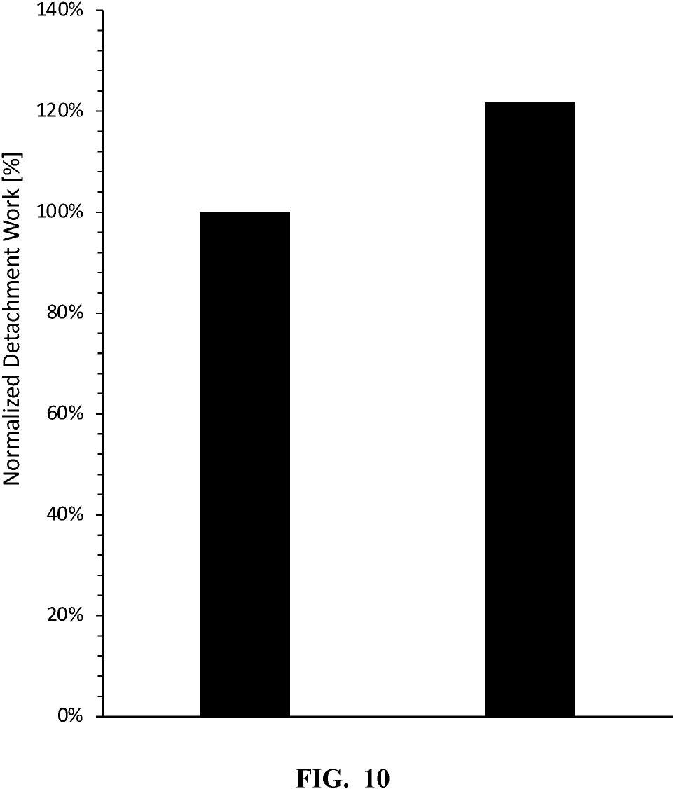

FIGS. 9 and 10 are comparative bar graphs plotting, respectively, the maximum detachment force and the detachment work required for this formulation, normalized with respect to the maximum detachment force required for the pure sucrose control sample (i.e., defined as 100%).

It may be observed that the formulation of Example 9 attained a maximum detachment force of about 140%, and a detachment work of about 120%, with respect to the sucrose control sample.

### Examples 109-110

The formulations disclosed in Examples 54A and 56 were used to prepare Butter Cookie Samples, according to Example 74B. Pair-comparison test results of the pair-comparison tests, performed and evaluated according to Example 74C, are listed below in Table 8.

TABLE 8

| % Sodium Alginate in Butter Cookie | Comparative Sweetness Index (CSI) |
|---|---|
| 0.3 | 88 |
| 0.5 | 66 |

### Additional Embodiments

Additional Embodiments 1 to 248 are provided hereinbelow.

Embodiment 1. A formulation comprising:
(a) sweetener particles containing a sweetener selected from the group consisting of a sweetener carbohydrate and a sweetener polyol; and
(b) a polysaccharide disposed within the sweetener particles;
wherein a weight-to-weight ratio of the polysaccharide to the sweetener within the sweetener particles is within a range of 0.03% to 1.75%.

Embodiment 2. A formulation comprising:
(a) sweetener particles containing a sweetener selected from the group consisting of a sweetener carbohydrate and a sweetener polyol; and
(b) a polysaccharide disposed within the sweetener particles;
wherein the polysaccharide is a mucoadhesive agent; and wherein a mucosal adhesion of the formulation is greater than that of a control composition, the control composition being devoid of the polysaccharide, but being otherwise identical to the formulation; and wherein a weight-to-weight ratio of the polysaccharide to the sweetener within the sweetener particles, or within the sweetener particles, is within a weight range of 0.03% to 1.75%.

Embodiment 3. A formulation comprising:
(a) sweetener particles containing a sweetener selected from the group consisting of a sweetener carbohydrate and a sweetener polyol; and
(b) a polysaccharide disposed within the sweetener particles;
wherein a weight content of the polysaccharide within the formulation, on a dry basis, is within a range of 0.005% to 1.75%.

Embodiment 4. A formulation comprising:
(a) sweetener particles containing a sweetener selected from the group consisting of a sweetener carbohydrate and a sweetener polyol; and
(b) a polysaccharide disposed within the sweetener particles;
wherein an average particle size, by weight, of the sweetener particles within the formulation is at least 50 µm; and wherein the sweetener particles are predominantly crystalline.

Embodiment 5. A formulation comprising:
(a) sweetener particles containing a sweetener selected from the group consisting of a sweetener carbohydrate and a sweetener polyol; and
(b) a polysaccharide disposed within the sweetener particles;
wherein an average molecular weight of the polysaccharide disposed within the sweetener particles, in Daltons, is within a range of 8,000 to 2,000,000.

Embodiment 6. A formulation comprising:
(a) sweetener particles containing a sweetener selected from the group consisting of a sweetener carbohydrate and a sweetener polyol; and
(b) a polysaccharide disposed within the sweetener particles;
wherein an average degree of polymerization of the polysaccharide disposed within the sweetener particles is within a range of 50 to 40,000 monosaccharide building blocks.

Embodiment 7. A formulation comprising:
(a) sweetener particles containing a sweetener selected from the group consisting of a sweetener carbohydrate and a sweetener polyol; and
(b) a polysaccharide disposed within the sweetener particles;
wherein the polysaccharide is a mucoadhesive agent.

Embodiment 8. A formulation comprising:
(a) sweetener particles containing a sweetener selected from the group consisting of a sweetener carbohydrate and a sweetener polyol; and
(b) a polysaccharide disposed within the sweetener particles;
wherein a mucosal adhesion of the formulation is greater than that of a control composition, the control composition being devoid of the polysaccharide, but being otherwise identical to the formulation.

Embodiment 9. A formulation comprising:
(a) sweetener particles containing a sweetener selected from the group consisting of a sweetener carbohydrate and a sweetener polyol; and
(b) a polysaccharide disposed within the sweetener particles;
wherein a mucosal adhesion of the formulation is greater than that of a control composition by at least 1%, the control composition being devoid of the polysaccharide, but being otherwise identical to the formulation.

Embodiment 10. A formulation comprising:
(a) sweetener particles containing a sweetener selected from the group consisting of a sweetener carbohydrate and a sweetener polyol; and
(b) a polysaccharide disposed within the sweetener particles;
wherein a weight ratio of a total amount of polysaccharides in the formulation to the amount of the polysaccharide distributed within the sweetener particles is at most 10.

Embodiment 11. A formulation comprising:
(a) sweetener particles containing a sweetener selected from the group consisting of a sweetener carbohydrate and a sweetener polyol; and
(b) a polysaccharide disposed within the sweetener particles;
wherein the polysaccharide distributed within the sweetener particles includes a first particular polysaccharide, and wherein a weight ratio of a total amount of the first particular polysaccharide in the formulation to the amount of the first particular polysaccharide distributed within the sweetener particles is at most 5.

Embodiment 12. A formulation comprising:
(a) sweetener particles containing a sweetener selected from the group consisting of a sweetener carbohydrate and a sweetener polyol; and
(b) a polysaccharide disposed within the sweetener particles;
wherein glycosidic linkages within the polysaccharide are O-glycosidic linkages [oxygenic linkages (—O—)]; and wherein a weight-to-weight ratio of the polysaccharide to the sweetener within the sweetener particles is within a range of 0.05% to 1.50%.

Embodiment 13. A formulation comprising:
(a) sweetener particles containing a sweetener including a sweetener carbohydrate, and optionally, a sweetener polyol; and
(b) a polysaccharide disposed within the sweetener particles;
wherein glycosidic linkages within the polysaccharide are O-glycosidic linkages [oxygenic linkages (—O—)]; wherein a total weight content of the sweetener within the formulation, is at least 25%, on a dry basis; and wherein an average molecular weight of the polysaccharide disposed within the sweetener particles, in Daltons, is within a range of 8,000 to 2,000,000.

Embodiment 14. A formulation comprising:
(a) sweetener particles containing a sweetener including a sweetener polyol, and optionally, a sweetener carbohydrate; and
(b) a polysaccharide disposed within the sweetener particles;
wherein glycosidic linkages within the polysaccharide are O-glycosidic linkages [oxygenic linkages (—O—)]; wherein a total weight content of the sweetener within the formulation, is at least 25%, on a dry basis; and wherein an average molecular weight of the polysaccharide disposed within the sweetener particles, in Daltons, is within a range of 8,000 to 2,000,000.

Embodiment 15. A formulation comprising:
(a) sweetener particles containing a sweetener including a sweetener carbohydrate, and optionally, a sweetener polyol; and
(b) a polysaccharide disposed within the sweetener particles;
wherein glycosidic linkages within the polysaccharide are O-glycosidic linkages [oxygenic linkages (—O—)]; wherein a weight-to-weight ratio of the polysaccharide to the sweetener within the sweetener particles is within a range of 0.03% to 1.75%; and wherein the polysaccharide is a mucoadhesive agent.

Embodiment 16. A formulation comprising:
(a) sweetener particles containing a sweetener including a sweetener polyol, and optionally, a sweetener carbohydrate; and
(b) a polysaccharide disposed within the sweetener particles;
wherein glycosidic linkages within the polysaccharide are O-glycosidic linkages [oxygenic linkages (—O—)]; wherein a weight-to-weight ratio of the polysaccharide to the sweetener within the sweetener particles is within a range of 0.03% to 1.75%; and wherein the polysaccharide is a mucoadhesive agent.

Embodiment 17. An edible formulation comprising:
(a) sweetener particles containing a sweetener carbohydrate and optionally containing a sweetener polyol; and
(b) a polysaccharide disposed within the sweetener particles;
wherein glycosidic linkages within the polysaccharide are O-glycosidic linkages [oxygenic linkages (—O—)]; wherein a weight-to-weight ratio of the polysaccharide to the sweetener within the sweetener particles is within a range of 0.03% to 1.75%; wherein a total weight content of the sweetener polyol, and the sweetener carbohydrate, within the formulation, is at least 25%; wherein an average particle size, by weight, of the sweetener particles within the formulation is at least 50 µm; and wherein the polysaccharide is a mucoadhesive agent.

Embodiment 18. A formulation comprising:
(a) sweetener particles containing a sweetener polyol, and optionally containing a sweetener carbohydrate; and
(b) a polysaccharide disposed within the sweetener particles;
wherein glycosidic linkages within the polysaccharide are O-glycosidic linkages [oxygenic linkages (—O—)]; wherein a weight-to-weight ratio of the polysaccharide to the sweetener within the sweetener particles is within a range of 0.03% to 1.75%; wherein a total weight content of the sweetener polyol, and the sweetener carbohydrate, within the formulation, is at least 25%; wherein an average particle size, by weight, of the sweetener particles within the edible formulation is at least 50 µm; and wherein the polysaccharide is a mucoadhesive agent.

Embodiment 19. A formulation comprising:
(a) sweetener particles containing a sweetener selected from the group consisting of a sweetener carbohydrate and a sweetener polyol; and
(b) a polysaccharide disposed within the sweetener particles;
wherein the polysaccharide is a mucoadhesive agent; and wherein a mucosal adhesion of the sweetener formulation is greater than that of a control composition, the control composition being devoid of the polysaccharide, but being otherwise identical to the formulation; and wherein a weight-to-weight ratio of the at least one polysaccharide to the sweetener within the sweetener particles is within a weight range of 0.03% to 1.75%. Embodiment 20. The formulation of any one of the preceding Embodiments, wherein the sweetener contains a sweetener carbohydrate.

Embodiment 21. The formulation of any one of the preceding Embodiments, wherein the sweetener contains a sweetener polyol.

Embodiment 22. An edible formulation comprising:
(a) sweetener particles containing a sweetener including a sweetener carbohydrate, and optionally, a sweetener polyol; and
(b) at least one polysaccharide disposed within the sweetener particles;
(c) at least one fat; and
(d) optionally, at least one starch;
wherein a weight-to-weight ratio of the at least one polysaccharide to the sweetener within the sweetener particles is within a weight range of 0.03% to 1.75%; and wherein a total concentration of the sweetener, the at least one fat, and the at least one starch, within the edible formulation, is at least 30%, on a weight basis.

Embodiment 23. The edible formulation of Embodiment 22, wherein a weight content of the sweetener within the formulation is at least 8%.

Embodiment 24. The edible formulation of Embodiment 22 or 23, containing at least 5% of the sweetener, and at least 5% of the at least one fat.

Embodiment 25. The edible formulation of any one of Embodiments 22 to 24, containing at least 5% of the sweetener, and at least 5% of the at least one starch.

Embodiment 26. The edible formulation of any one of Embodiments 22 to 25, wherein a weight concentration of the sweetener particles within the edible formulation is within a range of 10% to 80%.

Embodiment 27. The formulation of any one of the preceding Embodiments, wherein the sweetener is at least predominantly crystalline.

Embodiment 28. The formulation of any one of the preceding Embodiments, wherein the weight range is 0.05% to 1.2%.

Embodiment 29. The formulation of any one of the preceding Embodiments, wherein the weight-to-weight ratio is at most 1.0%.

Embodiment 30. The formulation of any one of the preceding Embodiments, wherein the weight-to-weight ratio is at least 0.1%.

Embodiment 31. The formulation of any one of the preceding Embodiments, wherein a weight concentration of the sweetener particles within the formulation is at least 50%.

Embodiment 32. The formulation of any one of the preceding Embodiments, wherein a weight concentration of the sweetener within the formulation is at least 80%.

Embodiment 33. The formulation of any one of the preceding Embodiments, wherein a or the weight-to-weight ratio of the polysaccharide to the sweetener within the sweetener particles is within a range of 0.03% to 1.75%.

Embodiment 34. The formulation of any one of the preceding Embodiments, wherein a or the weight content of the polysaccharide within the formulation, on a dry basis, is within a range of 0.005% to 1.75%.

Embodiment 35. The formulation of any one of the preceding Embodiments, wherein an average particle size, by weight, of the sweetener particles within the formulation is at least 80 µm.

Embodiment 36. The formulation of any one of the preceding Embodiments, wherein an average molecular weight of the polysaccharide disposed within the sweetener particles, in Daltons, is within a range of 10,000 to 2,000,000.

Embodiment 37. The formulation of any one of the preceding Embodiments, wherein an average degree of polymerization of the polysaccharide disposed within the sweetener particles is within a range of 50 to 40,000 monosaccharide building blocks.

Embodiment 38. The formulation of any one of the preceding Embodiments, wherein the polysaccharide is a mucoadhesive agent.

Embodiment 39. The formulation of any one of the preceding Embodiments, wherein a or the mucosal adhesion of the formulation is greater than that of a control composition, the control composition being devoid of the polysaccharide, but being otherwise identical to the formulation.

Embodiment 40. The formulation of Embodiment 39, wherein the mucosal adhesion is greater than that of the control composition by a value within a mucosal adhesion range of 1% to 200%.

Embodiment 41. The formulation of any one of the preceding Embodiments, wherein the mucosal adhesion range is 1% to 80%.

Embodiment 42. The formulation of Embodiment 40, wherein the mucosal adhesion range is 1.5% to 60%.

Embodiment 43. The formulation of Embodiment 40, wherein the mucosal adhesion range is 2% to 50%.

Embodiment 44. The formulation of Embodiment 40, wherein the mucosal adhesion range is 3% to 40%.

Embodiment 45. The formulation of Embodiment 40, wherein the mucosal adhesion range is 5% to 30%.

Embodiment 46. The formulation of Embodiment 40, wherein the mucosal adhesion range is 1% to 90%.

Embodiment 47. The formulation of Embodiment 40, wherein the mucosal adhesion range is 2% to 90%.

Embodiment 48. The formulation of Embodiment 40, wherein the mucosal adhesion range is 2% to 70%.

Embodiment 49. The formulation of Embodiment 40, wherein the mucosal adhesion range is 2% to 60%.

Embodiment 50. The formulation of Embodiment 40, wherein the mucosal adhesion range is 2% to 45%.

Embodiment 51. The formulation of Embodiment 40, wherein the mucosal adhesion range is 2.5% to 60%.

Embodiment 52. The formulation of Embodiment 40, wherein the mucosal adhesion range is 2.5% to 45%.

Embodiment 53. The formulation of Embodiment 40, wherein the mucosal adhesion range is 3% to 70%.

Embodiment 54. The formulation of Embodiment 40, wherein the mucosal adhesion range is 3% to 60%.

Embodiment 55. The formulation of Embodiment 40, wherein the mucosal adhesion range is 3% to 50%.

Embodiment 56. The formulation of Embodiment 40, wherein the mucosal adhesion range is 4% to 50%.

Embodiment 57. The formulation of any one of Embodiments 46-56, wherein the mucosal adhesion range is at most 40%.

Embodiment 58. The formulation of any one of Embodiments 40-57, wherein the mucosal adhesion range is at least 5%.

Embodiment 59. The formulation of any one of Embodiments 40-57, wherein the mucosal adhesion range is at least 6%.

Embodiment 60. The formulation of any one of Embodiments 40-57, wherein the mucosal adhesion range is at least 7%.

Embodiment 61. The formulation of any one of Embodiments 46-60, wherein the mucosal adhesion range is at most 35%.

Embodiment 62. The formulation of any one of Embodiments 46-60, wherein the mucosal adhesion range is at most 32%.

Embodiment 63. The formulation of Embodiments 39-62, wherein a or the value of the mucosal adhesion of the formulation is determined by a maximum detachment force (F_{DmaX}).

Embodiment 64. The formulation of Embodiments 39-62, wherein a or the value of the mucosal adhesion of the formulation is determined by a maximum force of detachment determination (F_{D-D}).

Embodiment 65. The formulation of Embodiments 39-62, wherein a or the value of the mucosal adhesion of the formulation is determined by a detachment work (W_{D}).

Embodiment 66. The formulation of Embodiments 39-62, wherein a or the value of the mucosal adhesion of the formulation is determined by a work of detachment determination (W_{D-D}).

Embodiment 67. The formulation of any one of the preceding Embodiments, wherein the formulation is a bioadhesive formulation.

Embodiment 68. The formulation of Embodiment 67, wherein the bioadhesive formulation contains a bioadhesive concentration of polysaccharide.

Embodiment 69. The formulation of Embodiment 67, wherein the bioadhesive formulation contains a bioadhesive content of polysaccharide.

Embodiment 70. The formulation of any one of the preceding Embodiments, wherein a weight ratio of a total amount of polysaccharides in the formulation to the amount of the polysaccharide distributed within the sweetener particles is at most 8.

Embodiment 71. The formulation of any one of the preceding Embodiments, wherein the polysaccharide distributed within the sweetener particles is a first particular polysaccharide, and wherein a weight ratio of a total amount of the first particular polysaccharide in the formulation to the amount of the first particular polysaccharide distributed within the sweetener particles is at most 4.

Embodiment 72. The formulation of any one of the preceding Embodiments, wherein an average particle size, by weight, of the sweetener particles within the formulation is at least 140 µm.

Embodiment 73. The formulation of any one of the preceding Embodiments, wherein monosaccharide building blocks of the polysaccharide comprise alkali cations, and wherein a molar ratio of the alkali cations to silicon disposed within the formulation is at least 3:1.

Embodiment 74. The formulation of any one of the preceding Embodiments, wherein monosaccharide building blocks of the polysaccharide comprise alkali cations, and wherein a molar ratio of the alkali cations to silicon disposed within the sweetener particles is at least 5:1, and optionally, at least 10:1.

Embodiment 75. The formulation of any one of the preceding Embodiments, wherein the polysaccharide distributed within the sweetener particles is a first particular polysaccharide, and wherein a weight ratio of a total amount of the first particular polysaccharide in the formulation to the amount of the first particular polysaccharide distributed within the sweetener particles is at most 2.5.

Embodiment 76. The formulation of Embodiment 75, wherein the weight ratio of the total amount of the first particular polysaccharide in the formulation to the amount of the first particular polysaccharide distributed within the sweetener particles is at most 1.5, at most 1.0, or at most 0.5.

Embodiment 77. The formulation of any one of the preceding Embodiments, wherein a or the total weight content of the sweetener particles within the formulation is at least 25%, and optionally, at least 30%, at least 40%, or at least 50%.

Embodiment 78. The formulation of any one of the preceding Embodiments, wherein a total weight content of the sweetener particles within the formulation is within a range of 10% to 80%.

Embodiment 79. The formulation of Embodiment 77, wherein the total weight content of the sweetener particles within the formulation is within a range of 15% to 70%.

Embodiment 80. The formulation of any one of the preceding Embodiments, wherein a or the total weight content of the sweetener within the formulation is at least 25%.

Embodiment 81. The formulation of any one of the preceding Embodiments, wherein a total weight content of the sweetener within the formulation is within a range of 10% to 80%.

Embodiment 82. The formulation of Embodiment 81, wherein the total weight content of the sweetener within the formulation is within a range of 15% to 70%.

Embodiment 83. The formulation of Embodiment 81, wherein the total weight content of the sweetener within the formulation is within a range of 25% to 70%.

Embodiment 84. The formulation of any one of the preceding Embodiments, wherein a or the weight content of the sweetener within the formulation is at least 30%.

Embodiment 85. The formulation of any one of the preceding Embodiments, wherein a weight content of the sweetener within the formulation is at least 40%.

Embodiment 86. The formulation of any one of the preceding Embodiments, wherein a weight content of the sweetener within the formulation is at least 50%.

Embodiment 87. The formulation of any one of the preceding Embodiments, wherein a weight content of the sweetener within the formulation is at least 65%.

Embodiment 88. The formulation of any one of the preceding Embodiments, wherein a weight content of the sweetener within the formulation is at least 75%.

Embodiment 89. The formulation of any one of the preceding Embodiments, wherein a weight content of the sweetener within the formulation is at least 85%.

Embodiment 90. The formulation of any one of the preceding Embodiments, wherein a weight content of the sweetener within the formulation is at least 90%.

Embodiment 91. The formulation of any one of the preceding Embodiments, wherein a weight content of the sweetener within the formulation is at least 95%.

Embodiment 92. The formulation of any one of the preceding Embodiments, wherein the sweetener particles have an average particle size (Dv50) of at least 30 µm.

Embodiment 93. The formulation of any one of the preceding Embodiments, wherein the sweetener particles have an average particle size (Dv50) within a range of 30 µm to 1500 µm.

Embodiment 94. The formulation of any one of the preceding Embodiments, wherein the formulation or the sweetener particles have an average particle size (Dv50) of at least 50 µm.

Embodiment 95. The formulation of any one of the preceding Embodiments, wherein the formulation or the sweetener particles have an average particle size (Dv50) of at least 100 µm.

Embodiment 96. The formulation of any one of the preceding Embodiments, wherein the formulation or the sweetener particles have an average particle size (Dv50) of at least 200 µm.

Embodiment 97. The formulation of any one of the preceding Embodiments, wherein the formulation or the sweetener particles have an average particle size (Dv50) of at least 350 µm.

Embodiment 98. The formulation of any one of the preceding Embodiments, wherein the formulation or the sweetener particles have an average particle size (Dv50) within a range of 100 µm to 1000 µm.

Embodiment 99. The formulation of any one of the preceding Embodiments, wherein the weight-to-weight ratio is within a range of 0.03% to 1.5%, 0.03% to 1.2%, 0.03% to 1.0%, 0.03% to 0.8%, 0.03% to 0.7%, 0.03% to 0.6%, 0.03% to 0.5%, 0.05% to 1.75%, 0.05% to 1.5%, 0.05% to 1.4%, 0.05% to 1.3%, 0.05% to 1.2%, 0.05% to 1.0%, 0.05% to 0.7%, 0.1% to 1.75%, 0.1% to 1.5%, 0.1% to 1.4%, 0.1% to 1.3%, 0.1% to 1.2%, 0.1% to 1.0%, 0.1% to 0.8%, 0.1% to 0.7%, 0.1% to 0.6%, 0.15% to 1.75%, 0.15% to 1.5%, 0.15% to 1.4%, 0.15% to 1.3%, 0.15% to 1.2%, 0.15% to 1.0%, 0.15% to 0.8%, 0.2% to 1.75%, 0.2% to 1.5%, 0.2% to 1.4%, 0.2% to 1.3%, 0.2% to 1.2%, 0.2% to 1.0%, 0.2% to 0.8%, 0.2% to 0.7%, 0.2% to 0.6%, 0.25% to 1.75%, 0.25% to 1.5%, 0.25% to 1.4%, 0.25% to 1.3%, 0.25% to 1.2%, 0.25% to 1.0%, 0.25% to 0.8%, 0.25% to 0.7%, or 0.25% to 0.6%.

Embodiment 100. The formulation of any one of the preceding Embodiments, wherein the weight-to-weight ratio of the polysaccharide to the sweetener within the sweetener particles is within a range of 0.05% to 1.5%.

Embodiment 101. The formulation of any one of the preceding Embodiments, wherein the weight-to-weight ratio of the polysaccharide to the sweetener within the sweetener particles is within a range of 0.1% to 1.5%.

Embodiment 102. The formulation of any one of the preceding Embodiments, wherein the weight-to-weight ratio of the polysaccharide to the sweetener within the sweetener particles is within a range of 0.1% to 1.25%.

Embodiment 103. The formulation of any one of the preceding Embodiments, wherein the weight-to-weight ratio of the polysaccharide to the sweetener within the sweetener particles is within a range of 0.1% to 1.0%.

Embodiment 104. The formulation of any one of the preceding Embodiments, wherein the weight-to-weight ratio of the polysaccharide to the sweetener within the sweetener particles is within a range of 0.1% to 0.8%.

Embodiment 105. The formulation of any one of the preceding Embodiments, wherein the weight-to-weight ratio of the polysaccharide to the sweetener within the sweetener particles is within a range of 0.1% to 0.7%.

Embodiment 106. The formulation of any one of the preceding Embodiments, wherein the weight content of the polysaccharide within the formulation, on a or the dry basis, is at least 0.007%, at least 0.01%, at least 0.025%, at least 0.05%, at least 0.075%, at least 0.1%, at least 0.2%, at least 0.3%, at most 1.5%, at most 1.3%, at most 1.2%, at most 1.1%, at most 1.0%, at most 0.9%, at most 0.8%, at most 0.7%, or at most 0.6%, or within a range of 0.005% to 1.5%, 0.005% to 1.35%, 0.005% to 1.2%, 0.01% to 1.2%, 0.01% to 1.1%, 0.01% to 1.0%, 0.01% to 0.9%, 0.025% to 1.2%, 0.025% to 1.1%, 0.025% to 1.0%, 0.025% to 0.9%, 0.05% to 1.2%, 0.05% to 1.1%, 0.05% to 1.0%, 0.05% to 0.9%, 0.1% to 1.2%, 0.1% to 1.1%, 0.1% to 1.0%, 0.1 % to 0.9%, 0.1 % to 0.8%, or 0.1 % to 0.7%.

Embodiment 107. The formulation of any one of the preceding Embodiments, wherein the weight content of the polysaccharide within the formulation, on a or the dry basis, is within a range of 0.005% to 1%.

Embodiment 108. The formulation of Embodiment 107, wherein the weight content of the polysaccharide within the formulation, on the dry basis, is within a range of 0.015% to 0.3%.

Embodiment 109. The formulation of Embodiment 107, wherein the weight content of the polysaccharide within the formulation, on the dry basis, is within a range of 0.015% to 0.1%.

Embodiment 110. The formulation of any one of the preceding Embodiments, wherein the average particle size, by weight, of the sweetener particles within the formulation is at least 60 µm, at least 80 µm, at least 100 µm, at least 120 µm, at least 15 µm; at least 200 µm; at least 220 µm; at least 240 µm, or within a range of 60 µm to 1200 µm, 100 µm to 1200 µm, 120 µm to 1200 µm, 160 µm to 1200 µm, 200 µm to 1200 µm, 240 µm to 1200 µm, 120 µm to 1000 µm, 150 µm to 1000 µm, 180 µm to 1000 µm, 200 µm to 1000 µm, 220 µm to 1000 µm, 240 µm to 1000 µm, 120 µm to 800 µm, 150 µm to 800 µm, 180 µm to 800 µm, 200 µm to 800 µm, 250 µm to 800 µm, or 300 µm to 1200 µm.

Embodiment 111. The formulation of any one of the preceding Embodiments, wherein the average particle size, by weight, of the sweetener particles within the formulation is at least 120 µm.

Embodiment 112. The formulation of Embodiment 111, wherein the average particle size, by weight, of the sweetener particles within the formulation is within a range of 150 µm to 1200 µm.

Embodiment 113. The formulation of any one of the preceding Embodiments, wherein the average molecular weight of the polysaccharide disposed within the sweetener particles, in Daltons, is within a range of 15,000 to 2,000,000; 35,000 to 2,000,000; 50,000 to 2,000,000; 75,000 to 2,000,000; 100,000 to 2,000,000; 100,000 to 1,500,000; 100,000 to 1,000,000; 150,000 to 2,000,000; 200,000 to 2,000,000; 200,000 to 1,500,000; 200,000 to 1,200,000; 200,000 to 1,000,000; 300,000 to 2,000,000; 300,000 to 1,500,000; 300,000 to 1,200,000; 300,000 to 1,000,000; 300,000 to 800,000; 150,000 to 400,000; 100,000 to 800,000; 100,000 to 650,000; 100,000 to 500,000; or 100,000 to 400,000.

Embodiment 114. The formulation of Embodiment 113, wherein the average molecular weight of the polysaccharide disposed within the sweetener particles, in Daltons, is within a range of 15,000 to 2,000,000.

Embodiment 115. The formulation of Embodiment 113, wherein the average molecular weight of the polysaccharide disposed within the sweetener particles, in Daltons, is within a range of 35,000 to 1,200,000.

Embodiment 116. The formulation of Embodiment 113, wherein the average molecular weight of the polysaccharide disposed within the sweetener particles, in Daltons, is within a range of 50,000 to 1,000,000.

Embodiment 117. The formulation of Embodiment 113, wherein the average molecular weight of the polysaccharide disposed within the sweetener particles, in Daltons, is within a range of 15,000 to 400,000.

Embodiment 118. The formulation of any one of the preceding Embodiments, wherein the average degree of polymerization of the polysaccharide disposed within the sweetener particles is within a range of 50 to 10,000 monosaccharide building blocks.

Embodiment 119. The formulation of Embodiment 118, wherein the average degree of polymerization of the polysaccharide disposed within the sweetener particles is within a range of 50 to 1,500 monosaccharide building blocks.

Embodiment 120. The formulation of Embodiment 118, wherein the average degree of polymerization of the polysaccharide disposed within the sweetener particles is at least 120 monosaccharide building blocks.

Embodiment 121. The formulation of any one of the preceding Embodiments, wherein the average degree of polymerization of the polysaccharide disposed within the sweetener particles is at least 400 monosaccharide building blocks.

Embodiment 122. The formulation of any one of the preceding Embodiments, wherein the average degree of polymerization of the polysaccharide disposed within the sweetener particles is at most 700 monosaccharide building blocks.

Embodiment 123. The formulation of any one of the preceding Embodiments, wherein the substituted monosaccharides contain an acetate moiety.

Embodiment 124. The formulation of any one of the preceding Embodiments, wherein the substituted monosaccharides contain a methoxy moiety.

Embodiment 125. The formulation of any one of the preceding Embodiments, wherein the substituted monosaccharides contain a pyruvate moiety.

Embodiment 126. The formulation of any one of the preceding Embodiments, wherein the substituted monosaccharides contain a sulfate moiety.

Embodiment 127. The formulation of any one of the preceding Embodiments, wherein a weight ratio of a total amount of polysaccharides in the formulation to the amount of the polysaccharide distributed within the sweetener particles is at most 2.0.

Embodiment 128. The formulation of any one of the preceding Embodiments, wherein a weight ratio of a total amount of polysaccharides in the formulation to the amount of the polysaccharide distributed within the sweetener particles is at most 1.25.

Embodiment 129. The formulation of any one of the preceding Embodiments, wherein the weight ratio of the total amount of the first particular polysaccharide in the formulation to the amount of the first particular polysaccharide distributed within the sweetener particles is at most 2.0.

Embodiment 130. The formulation of any one of the preceding Embodiments, wherein the weight ratio of the total amount of the first particular polysaccharide in the formulation to the amount of the first particular polysaccharide distributed within the sweetener particles is at most 1.5.

Embodiment 131. The formulation of any one of the preceding Embodiments, wherein the weight ratio of the total amount of the first particular polysaccharide in the formulation to the amount of the first particular polysaccharide distributed within the sweetener particles is at most 1.25.

Embodiment 132. The formulation of any one of the preceding Embodiments, wherein the weight ratio of the total amount of the first particular polysaccharide in the formulation to the amount of the first particular polysaccharide distributed within the sweetener particles is at most 1.1.

Embodiment 133. The formulation of any one of the preceding Embodiments, wherein the polysaccharide is a homopolysaccharide.

Embodiment 134. The formulation of any one of the preceding Embodiments, wherein the polysaccharide is a heteropolysaccharide.

Embodiment 135. The formulation of any one of the preceding Embodiments, wherein the polysaccharide is a linear polysaccharide.

Embodiment 136. The formulation of any one of the preceding Embodiments, wherein the polysaccharide is a branched polysaccharide.

Embodiment 137. The formulation of any one of the preceding Embodiments, wherein the polysaccharide is an anionic polysaccharide.

Embodiment 138. The formulation of any one of the preceding Embodiments, wherein the polysaccharide is a non-ionic polysaccharide.

Embodiment 139. The formulation of any one of the preceding Embodiments, wherein the monosaccharide building blocks are cyclic monosaccharides. Embodiment 140. The formulation of any one of the preceding Embodiments, wherein the monosaccharide building blocks are, or include, unsubstituted monosaccharides.

Embodiment 141. The formulation of Embodiment 140, wherein the unsubstituted monosaccharides include hexose sugars.

Embodiment 142. The formulation of Embodiment 140, wherein the unsubstituted monosaccharides include pentose sugars.

Embodiment 143. The formulation of Embodiment 140, wherein the unsubstituted monosaccharides include heptose sugars.

Embodiment 144. The formulation of any one of the preceding Embodiments, wherein the monosaccharide building blocks are, or include, substituted monosaccharides.

Embodiment 145. The formulation of Embodiment 144, wherein the substituted monosaccharides contain an amine moiety.

Embodiment 146. The formulation of Embodiment 144, wherein the substituted monosaccharides contain an acetyl moiety.

Embodiment 147. The formulation of Embodiment 144, wherein the substituted monosaccharides contain a carboxylate moiety.

Embodiment 148. The formulation of Embodiment 144, wherein the substituted monosaccharides are, or include, a uronic acid.

Embodiment 149. The formulation of any one of the preceding Embodiments, wherein the unsubstituted monosaccharides include glucose.

Embodiment 150. The formulation of any one of the preceding Embodiments, wherein the polysaccharide includes xylose.

Embodiment 151. The formulation of any one of the preceding Embodiments, wherein the polysaccharide includes arabinose.

Embodiment 152. The formulation of any one of the preceding Embodiments, wherein the polysaccharide includes rhamnose.

Embodiment 153. The formulation of any one of the preceding Embodiments, wherein the polysaccharide includes mannuronate.

Embodiment 154. The formulation of any one of the preceding Embodiments, wherein the polysaccharide includes galactose.

Embodiment 155. The formulation of any one of the preceding Embodiments, wherein the polysaccharide includes mannose.

Embodiment 156. The formulation of any one of the preceding Embodiments, wherein the polysaccharide includes glucuronate.

Embodiment 157. The formulation of any one of the preceding Embodiments, wherein the polysaccharide includes galactopyranose.

Embodiment 158. The formulation of any one of the preceding Embodiments, wherein the polysaccharide includes galacturonic acid.

Embodiment 159. The formulation of any one of the preceding Embodiments, wherein the heteropolysaccharide includes mannose and glucose.

Embodiment 160. The formulation of any one of the preceding Embodiments, wherein the heteropolysaccharide includes mannose and galactose.

Embodiment 161. The formulation of any one of the preceding Embodiments, wherein a molar ratio of the mannose to the galactose is between 1:1 and 6:1.

Embodiment 162. The formulation of any one of the preceding Embodiments, wherein the heteropolysaccharide includes mannuronate and glucuronate.

Embodiment 163. The formulation of any one of the preceding Embodiments, wherein the heteropolysaccharide includes mannuronate and glucuronate disposed in a block polymer structure.

Embodiment 164. The formulation of any one of the preceding Embodiments, wherein the heteropolysaccharide includes mannuronate and glucuronate disposed in an alternating structure.

Embodiment 165. The formulation of any one of the preceding Embodiments, wherein the polysaccharide includes an arabinogalactan proteoglycan.

Embodiment 166. The formulation of any one of the preceding Embodiments, wherein the polysaccharide includes β-D-mannopyranosyl units.

Embodiment 167. The formulation of any one of the preceding Embodiments, wherein the polysaccharide has a β-D-Glucose backbone having mannose and glucuronic acid side chains.

Embodiment 168. The formulation of any one of the preceding Embodiments, wherein the polysaccharide includes xanthan gum.

Embodiment 169. The formulation of any one of the preceding Embodiments, wherein the polysaccharide includes agar-agar.

Embodiment 170. The formulation of any one of the preceding Embodiments, wherein the polysaccharide includes gum Arabic.

Embodiment 171. The formulation of any one of the preceding Embodiments, wherein the polysaccharide includes Konjac Mannan.

Embodiment 172. The formulation of any one of the preceding Embodiments, wherein the polysaccharide includes an alkali alginate optionally selected from the group of sodium alginate and potassium alginate.

Embodiment 173. The formulation of any one of the preceding Embodiments, wherein the polysaccharide includes pectin.

Embodiment 174. The formulation of any one of the preceding Embodiments, wherein the polysaccharide includes guar gum.

Embodiment 175. The formulation of any one of the preceding Embodiments, wherein the polysaccharide includes gellan gum.

Embodiment 176. The formulation of any one of the preceding Embodiments, wherein the polysaccharide includes locust bean gum.

Embodiment 177. The formulation of any one of the preceding Embodiments, wherein the polysaccharide includes tara gum.

Embodiment 178. The formulation of any one of the preceding Embodiments, wherein the polysaccharide includes Karaya gum.

Embodiment 179. The formulation of any one of the preceding Embodiments, wherein the polysaccharide includes curdlan.

Embodiment 180. The formulation of any one of the preceding Embodiments, wherein the polysaccharide includes tragacanth.

Embodiment 181. The formulation of any one of the preceding Embodiments, wherein an or the alkali alginate has an average molecular weight above 10,000.

Embodiment 182. The formulation of Embodiment 181, wherein the alkali alginate has an average molecular weight above 50,000.

Embodiment 183. The formulation of any one of the preceding Embodiments, wherein an or the alkali alginate has an average molecular weight of at most 1,000,000.

Embodiment 184. The formulation of Embodiment 183, wherein the alkali alginate has an average molecular weight of at most 600,000.

Embodiment 185. The formulation of Embodiment 183, wherein the alkali alginate has an average molecular weight of at most 300,000.

Embodiment 186. The formulation of Embodiment 183, wherein the alkali alginate has an average molecular weight of at most 125,000.

Embodiment 187. The formulation of Embodiment 183, wherein the alkali alginate has an average molecular weight within a range of 10,000 to 1,000,000.

Embodiment 188. The formulation of Embodiment 183, wherein the alkali alginate has an average molecular weight within a range of 10,000 to 250,000.

Embodiment 189. The formulation of Embodiment 183, wherein the alkali alginate has an average molecular weight within a range of 10,000 to 120,000.

Embodiment 190. The formulation of Embodiment 183, wherein the alkali alginate has an average molecular weight within a range of 20,000 to 350,000.

Embodiment 191. The formulation of any one of the preceding Embodiments, wherein a molar ratio of the alkali alginate to silicon within the sweetener particles is at least 3:1, and optionally, at least 5:1, at least 10:1, or at least 50:1.

Embodiment 192. The formulation of any one of the preceding Embodiments, wherein the alkali alginate includes sodium alginate.

Embodiment 193 The formulation of any one of the preceding Embodiments, wherein the alkali alginate includes potassium alginate.

Embodiment 194. The formulation of any one of the preceding Embodiments, wherein the sweetener carbohydrate is selected from at least one of the group consisting of sucrose, glucose, fructose, maltose, lactose, mannose, allulose, tagatose, xylose, galactose, arabinose, galactofructose.

Embodiment 195. The formulation of any one of the preceding Embodiments, wherein the sweetener carbohydrate includes sucrose.

Embodiment 196. The formulation of any one of the preceding Embodiments, wherein the sweetener carbohydrate includes glucose.

Embodiment 197. The formulation of any one of the preceding Embodiments, wherein the sweetener carbohydrate includes fructose.

Embodiment 198. The formulation of any one of the preceding Embodiments, wherein the sweetener polyol is selected from at least one of the group consisting of xylitol, maltitol, erythritol, sorbitol, threitol, arabitol, hydrogenated starch hydrolysates (HSH), isomalt, lactitol, mannitol, and galactitol (dulcitol).

Embodiment 199. The formulation of any one of the preceding Embodiments, wherein the formulation is in the form of a particulate solid such as a free-flowing powder.

Embodiment 200. The formulation of Embodiment 199, wherein the particulate solid is a powder.

Embodiment 201. The formulation of any one of the preceding Embodiments, wherein glycosidic linkages within the polysaccharide include, or consist of, O-glycosidic linkages.

Embodiment 202. The formulation of any one of the preceding Embodiments, wherein a or the mucosal adhesion of the formulation is greater than that of a or said control composition by a first value of at least 1.5%, the control composition being devoid of the polysaccharide, but being otherwise identical to the formulation, the mucosal adhesion of the formulation and of the control composition being determined by at least one of a detachment work (W_{D}) and a work of detachment determination (W_{D-D}).

Embodiment 203. The formulation of Embodiment 202, wherein the mucosal adhesion of the formulation and of the control composition is determined by W_{D}.

Embodiment 204. The formulation of Embodiment 210, wherein the mucosal adhesion of the formulation and of the control composition is determined by W_{D-D}.

Embodiment 205. The formulation of any one of Embodiments 202 to 204, wherein the first value is at most 200%.

Embodiment 206. The formulation of any one of Embodiments 202 to 204, wherein the first value is within a range of 2% to 180%.

Embodiment 207. The formulation of any one of Embodiments 202 to 204, wherein the first value is within a range of 3% to 150%.

Embodiment 208. The formulation of any one of Embodiments 202 to 204, wherein the first value is within a range of 4% to 125%.

Embodiment 209. The formulation of any one of Embodiments 202 to 204, wherein the first value is within a range of 5% to 110%.

Embodiment 210. The formulation of any one of Embodiments 202 to 204, wherein the first value is within a range of 5% to 150%, 5% to 125%, 10% to 100%, 10% to 80%, 15% to 125%, 20% to 180%, 20% to 150%, 20% to 125%, 20% to 100%, 20% to 80%, 30% to 150%, 30% to 125%, 30% to 100%, or 30% to 80%.

Embodiment 211. The formulation of any one of Embodiments 202 to 210, wherein the first value is at most 100%, at most 90%, at most 80%, at most 70%, at most 60%, at most 50%, at most 40%, or at most 30%.

Embodiment 212. The formulation of any one of the preceding Embodiments, wherein a or the mucosal adhesion of the formulation is greater than that of a or said control composition by a second value of at least 3%, the control composition being devoid of the polysaccharide, but being otherwise identical to the formulation, the mucosal adhesion of the formulation and of the control composition being determined by at least one of a maximum detachment force (F_{DmaX}) and a maximum force of detachment determination (F_{D-D}).

Embodiment 213. The formulation of Embodiment 212, wherein the mucosal adhesion of the formulation and of the control composition is determined by F_{DmaX}.

Embodiment 214. The formulation of Embodiment 212, wherein the mucosal adhesion of the formulation and of the control composition is determined by F_{D-D}.

Embodiment 215. The formulation of any one of Embodiments 212 to 214, wherein the second value is at most 150%.

Embodiment 216. The formulation of any one of Embodiments 212 to 214, wherein the second value is within a range of 1% to 125%.

Embodiment 217. The formulation of any one of Embodiments 212 to 214, wherein the second value is within a range of 1.5% to 125%.

Embodiment 218. The formulation of any one of Embodiments 212 to 214, wherein the second value is within a range of 1.5% to 100%.

Embodiment 219. The formulation of any one of Embodiments 212 to 214, wherein the second value is within a range of 1.5% to 75%.

Embodiment 220. The formulation of any one of Embodiments 212 to 214, wherein the second value is within a range of 1.5% to 50%.

Embodiment 221. The formulation of any one of Embodiments 212 to 214, wherein the second value is within a range of 1% to 35%.

Embodiment 222. The formulation of any one of Embodiments 212 to 214, wherein the second value is within a range of 1% to 50%.

Embodiment 223. The formulation of any one of Embodiments 212 to 214, wherein the second value is within a range of 2% to 50%.

Embodiment 224. The formulation of any one of Embodiments 212 to 214, wherein the second value is within a range of 2% to 35%.

Embodiment 225. The formulation of any one of Embodiments 212 to 214, wherein the second value is within a range of 3% to 100%, 5% to 60%, 5% to 40%, 7% to 100%, 7% to 80%, 7% to 70%, 7% to 60%, 7% to 40%, or 7% to 25%.

Embodiment 226. The formulation of any one of Embodiments 212 to 225, wherein the second value is at most 65%, at most 60%, at most 55%, at most 50%, at most 45%, at most 40%, at most 35%, at most 30%, at most 25%, or at most 20%.

Embodiment 227. The formulation of any one of the preceding Embodiments, wherein the substituted monosaccharides contain an acyl moiety.

Embodiment 228. The formulation of any one of the preceding Embodiments, wherein the polysaccharide has a specific surface area of at most 150 m²/g.

Embodiment 229. The formulation of any one of the preceding Embodiments, wherein the polysaccharide has a specific surface area of at most 125 m²/g.

Embodiment 230. The formulation of any one of the preceding Embodiments, wherein the polysaccharide has a specific surface area of at most 100 m²/g.

Embodiment 231. The formulation of any one of the preceding Embodiments, wherein the polysaccharide has a specific surface area of at most 75 m²/g.

Embodiment 232. The formulation of any one of the preceding Embodiments, wherein the polysaccharide has a specific surface area of at most 50 m²/g.

Embodiment 233. The formulation of any one of the preceding Embodiments, wherein the polysaccharide has a specific surface area of at most 25 m²/g.

Embodiment 234. The formulation of any one of the preceding Embodiments, wherein the polysaccharide has a specific surface area of at most 10 m²/g.

Embodiment 235. The formulation of any one of the preceding Embodiments, wherein the polysaccharide has an average particle size (Dv50) of at least 5 µm.

Embodiment 236. The formulation of any one of the preceding Embodiments, wherein the polysaccharide has an average particle size (Dv50) of at least 10 µm.

Embodiment 237. The formulation of any one of the preceding Embodiments, wherein the polysaccharide has an average particle size (Dv50) of at least 20 µm.

Embodiment 238. The formulation of any one of the preceding Embodiments, wherein the polysaccharide has an average particle size (Dv50) of at least 35 µm or at least 50 µm.

Embodiment 239. The formulation of any one of the preceding Embodiments, wherein the polysaccharide is determined to be the mucoadhesive agent by a standard rheological determination.

Embodiment 240. The formulation of Embodiment 239, wherein the standard rheological determination yields a bioadhesion viscosity component (ηb) within a range of 3-200 mPa•s.

Embodiment 241. The formulation of Embodiment 240, wherein the bioadhesion viscosity component (ηb) is within a range of 3-150 mPa•s, 5-200 mPa•s, 5-150 mPa•s, 6-200 mPa•s, 6-150 mPa•s, 7-200 mPa•s, 7-150 mPa•s, 8-200 mPa•s, 8-150 mPa•s, 10-200 mPa•s, 10-150 mPa•s, 10-100 mPa•s, 12-200 mPa•s, 12-150 mPa•s, 15-200 mPa•s, 15-150 mPa•s, 20-200 mPa•s, 20-150 mPa•s, or 20-100 mPa•s.

Embodiment 242. The formulation of any one of the preceding Embodiments, wherein the formulation has a bioadhesive content of polysaccharide, and wherein a bioadhesion viscosity increase (Δηₚₛ) for the polysaccharide is at least 1.5 mPa•s.

Embodiment 243. The formulation of Embodiment 242, wherein Δη_{PS} is at least 2.0 mPa•s, at least 2.5 mPa•s, or at least 3.0 mPa•s.

Embodiment 244. The formulation of any one of the preceding Embodiments, containing at least 5% of the sweetener, and at least 5% of a or the at least one fat.

Embodiment 245. The formulation of any one of the preceding Embodiments, containing at least 5% of the sweetener, and at least 5% of a or the at least one starch.

Embodiment 246. The formulation of any one of the preceding Embodiments, containing at least 5% of the sweetener, at least 5% of a or the at least one fat, and at least 5% of a or the at least one starch.

Embodiment 247. The formulation of any one of the preceding Embodiments, containing at least 2%, at least 5%, or at least 10% of an edible filler.

Embodiment 248. The edible formulation of any one of the preceding Embodiments, containing at least 10% of the sweetener, at least 10% of a or the at least one fat, and at least 10% of a or the at least one starch.

Average molecular weight may be based on the number of molecules in the population, which is termed “number average molecular weight”, or “AMW_{N}”, or may be based on the weight of the molecules, which is termed “weight average molecular weight”, or “AMW₅₀”. As used herein in the specification and in the claims section that follows, the term “average molecular weight” refers to AMW₅₀, unless otherwise specified.

As opposed to small molecules, which may have a unique molecular weight readily derived from their chemical formula, generally provided in grams/mole, polymers and other macromolecules typically exist as a diverse population of distinct molecules, which are therefore characterized by an average molecular weight often expressed in Daltons.

The molecular weight or average molecular weight of such materials is generally provided by the manufacturer or supplier thereof. In addition, the molecular weight or average molecular weight of such materials may be independently determined by known analytical methods, including, by way of example, gel permeation chromatography, high pressure liquid chromatography (HPLC), or matrix-assisted laser desorption/ionization time-of-flight mass spectroscopy (MALDI-TOF MS).

Average molecular weight may be calculated based on the number of particles in the population (“D_{N}50”) or may be based on the volume of particles (Dv50). These measurements may be obtained by various known methods (e.g., DLS, microscopy).

Average particle size (D50) may be based on the number of particles in the population (“D_{N}50”) or may be based on the volume of particles (Dv50). These measurements may be obtained by various known methods including static light scattering (SLS), dynamic light scattering (DLS), sieving, and various methods of microscopy. Some methods may be preferred for larger ranges of particles, others may be preferred for smaller ranges of particles.

As used herein in the specification and in the claims section that follows, the term “specific surface area”, with respect to a polysaccharide, refers to a Brunauer-Emmett-Teller (BET) method according to ISO Standard 9277.

As used herein in the specification and in the claims section that follows, the term “starch” is meant to include edible starches that are used or may be used in foodstuffs. Typically, such starches include at least one of amylose and amylopectin, and more typically, both amylose and amylopectin. It will be appreciated that various modifications of starch may be made, in order to impart to a particular foodstuff, or to the starch therein, specific chemical and/or physical properties, including, by way of example, the prevention of gelling at cold temperatures, withstanding low pH, or resistance to high shear or to high temperatures.

Often, starch is present in an ingredient, e.g., flour. In white wheat flour, the starch content is typically about 68%. In oats, the starch content is typically about 58%.

In addition to including fats that are solid at room temperature (25° C.), e.g., beef fat, shortening, palm oil, and butter, as used herein in the specification and in the claims section that follows, the term “fat” is meant to include edible oils, including those that are liquid at room temperature, e.g., cooking oils. Specific examples of edible oils are olive oil, walnut oil, corn oil, and cottonseed oil.

Fats may be a separate ingredient, or may be an ingredient within a food ingredient. For example, hazelnut paste and cocoa powder both contain fat.

As used herein in the specification and in the claims section that follows, the term “percent”, or “%”, refers to percent by weight, unless specifically indicated otherwise. However, with specific regard to formulations containing at least one polysaccharide and at least one sweetener, the weight-percent of the polysaccharide is with respect to the sweetener. By way of example, in such a formulation containing 1.95 grams sodium alginate dispersed in a syrup containing 650 grams sucrose and 350 grams water, the weight-percent of calcium caseinate is 1.95/650 = 0.3%.

As used herein in the specification and in the claims section that follows, the term “predominantly crystalline”, with respect to a sweetener material, refers to a sweetener material having at least 80% crystalline character, e.g., as determined by quantitative X-Ray Diffraction (XRD). In some embodiments, the crystalline character of the sweetener material (e.g., sucrose), is at least 85%, at least 90%, at least 95%, or at least 98%, e.g., as determined by quantitative XRD.

Similarly, the term “ratio”, as used herein in the specification and in the claims section that follows, refers to a weight ratio, unless specifically indicated otherwise.

The modifier “about” and “substantially” used in connection with a quantity is inclusive of the stated value and has the meaning dictated by the context (for example, it includes at least the degree of error associated with the measurement of the particular quantity). When used with a specific value, it should also be considered as disclosing that value.

In the context of the present application and claims, the phrase “at least one of A and B” is equivalent to an inclusive “or”, and includes any one of “only A”, “only B”, or “A and B”. Similarly, the phrase “at least one of A, B, and C” is equivalent to an inclusive “or”, and includes any one of “only A”, “only B”, “only C”, “A and B”, “A and C”, “B and C”, or “A and B and C”.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A formulation comprising:
(a) sweetener particles containing a sweetener selected from the group consisting of a sweetener carbohydrate and a sweetener polyol; and
(b) a polysaccharide disposed within the sweetener particles;
wherein said polysaccharide is a mucoadhesive agent;
and wherein a mucosal adhesion of the formulation is greater than that of a control composition, the control composition being devoid of said polysaccharide, but being otherwise identical to the formulation;
wherein a weight-to-weight ratio of said polysaccharide to said sweetener within the sweetener particles is within a weight range of 0.03% to 1.75%;
and wherein said sweetener is predominantly crystalline.

2. The formulation of claim 1, wherein said mucosal adhesion is greater than that of said control composition by a value within a mucosal adhesion range of 1% to 200%.

3. The formulation of claim 2, wherein said mucosal adhesion range is 1% to 80%.

4. The formulation of claim 2, wherein said mucosal adhesion range is 1.5% to 60%.

5. The formulation of claim 2, wherein said mucosal adhesion range is 2% to 50%.

6. The formulation of claim 2, wherein said mucosal adhesion range is 5% to 30%.

7. The formulation of claim 1, wherein said weight range is 0.05% to 1.2%.

8. The formulation of claim 7, wherein said weight-to-weight ratio is at most 1.0%.

9. The formulation of claim 8, wherein said weight-to-weight ratio is at least 0.1%.

10. The formulation of claim 1, wherein the formulation or said sweetener particles have an average particle size (Dv50) within a range of 100 µm to 1000 µm.

11. The formulation of claim 1, wherein said polysaccharide has a specific surface area of at most 150 m²/g.

12. The formulation of claim 11, wherein said specific surface area is at most 50 m²/g.

13. The formulation of claim 1, wherein said polysaccharide has an average particle size (Dv50) of at least 5 µm.

14. The formulation of claim 13, wherein said average particle size (Dv50) of said polysaccharide is at least 20 µm.

15. The formulation of claim 1, wherein said polysaccharide includes an alkali alginate.

16. The formulation of claim 1, wherein a weight concentration of said sweetener particles within the formulation is at least 50%.

17. The formulation of claim 1, wherein a weight concentration of said sweetener within the formulation is at least 80%.

18. An edible formulation comprising:
(a) The formulation of claim 1;
(b) at least one fat; and
(c) optionally, at least one starch;
wherein a total concentration of said sweetener, said at least one fat, and said at least one starch, within the edible formulation, is at least 30%, on a weight basis.

19. The edible formulation of claim 18, wherein a weight content of said sweetener within the edible formulation is at least 8%.

20. The edible formulation of claim 18, containing at least 5% of said sweetener, and at least 5% of said at least one fat.

21-42. (canceled)
